(19) United States
(12) Patent Application Publication
(10) Pub. No.: US 2016/0035053 A1
(43) Pub. Date: Feb. 4, 2016

(54) WEB BASED ELECTRONIC AND PAPERLESS REAL ESTATE TRANSACTION AND CLOSING SYSTEM

(71) Applicant: Key DMS, Inc., Coral Springs, FL (US)

(72) Inventor: Mark GERHARDT, Lighthouse Point, FL (US)

(21) Appl. No.: 14/450,048

(22) Filed: Aug. 1, 2014

(51) Int. Cl. G06Q 50/16; H04L 29/06

(52) U.S. Cl. CPC G06Q 50/167; H04L 63/0435

(57) ABSTRACT

A real estate transaction system is provided. A host server is in communication with at least one network data server. The host server is configured to receive real estate transaction data associated with a real estate transaction and receive user data associated with a plurality of users associated with the real estate transaction. The host server is configured to create at least one document package corresponding to a plurality of electronic real estate transaction documents based at least in part on the real estate transaction data and user data, determine accessibility of each of the plurality of electronic real estate transaction documents for each of the plurality of users based at least in part on the real estate transaction data and user data and track modifications made to the plurality of electronic real estate transaction documents by at least one of plurality of users throughout the real estate transaction.

### CROSS-REFERENCE TO RELATED APPLICATION

Not applicable

### STATEMENT REGARDING FEDERALLY SPONSORED RESEARCH OR DEVELOPMENT

Not applicable.

### FIELD OF THE INVENTION

This invention relates generally to electronic real estate transaction systems and more particularly, to a web-based electronic and paperless real estate transaction system including a software based product comprising a paperless system for conducting, completing and closing real estate transactions on a collaborative website available in a secured cloud that limits access to authorized participants involved in the real estate transaction, generates and provides digitized real estate related documents, includes electronic signature software that enables selected participants to securely sign predetermined documents electronically and allows selected third party participants to view and participate in the transaction without granting signing authority.

### BACKGROUND OF THE INVENTION

Real estate transactions have traditionally been done in stages and in personal meetings. As such, it would take several weeks to coordinate and complete a real estate transaction. It would require multiple meetings between the seller, buyer, real estate agents, inspectors, mortgage brokers, insurance agents, lawyers and lenders. This traditional method of conducting real estate transactions was found to be highly inefficient. In addition, a problem existed with authenticating documents and signatures. However, as real estate transactions involve confidential information that must be protected and secured and require signatures from multiple participants that can be authenticated, traditional methods were considered to be the only reliable way to conduct these transaction.

With the advancements in electronic documents, various attempts at making software related real estate transaction systems that could be done via the Internet have been made. For instance, attempts have been made to provide documents electronically via the Internet but these systems still require traditional closings and mortgage approval because of the problems with authenticating documents and signatures. Attempts have also been made to provide electronic documents and accommodate electronic signatures, but authenticating the documents and signatures remain a problem.

### SUMMARY OF THE INVENTION

According to one embodiment of the invention, a real estate transaction system including at least one network data server is provided. A host server is in communication with the at least one network data server. The host server is configured to receive real estate transaction data associated with a real estate transaction and receive user data associated with a plurality of users associated with the real estate transaction. The plurality of users include at least a buyer and seller of real estate in the real estate transaction. The host server is configured to create at least one document package corresponding to a plurality of electronic real estate transaction documents based at least in part on the real estate transaction data and user data, and determine accessibility of each of the plurality of electronic real estate transaction documents for each of the plurality of users based at least in part on the real estate transaction data and user data. The host server is configured to track modifications made to the plurality of electronic real estate transaction documents by at least one of plurality of users throughout the real estate transaction. The modifications include at least digitally signing an electronic real estate transaction document and changing real estate transaction data associated a electronic real estate transaction document. The host server is configured to restrict the accessibility of at least one of the plurality of electronic real estate transaction documents after the at least one of the plurality of electronic real estate transaction documents have been digitally signed, and transmit modified electronic real estate transaction documents to the at least one network data server for storage.

According to one aspect of this embodiment, a first electronic real estate transaction document of the plurality of electronic real estate transaction documents is divided into a plurality of sections. The accessibility of each of the sections is based at least in part on the user. One of the plurality of users is granted access to a first section of the first electronic real estate transaction document and not granted access to a second section of the first electronic real estate transaction document.

According to another aspect of this embodiment, the at least one network data server is configured to receive the real estate transaction data from host server, process the plurality of electronic real estate transaction documents and the real estate transaction data, encrypt the plurality of real estate transaction documents and the real estate transaction data and provide encrypted data storage for storing the plurality of real estate transaction documents and the real estate transaction data. The at least one network data server is configured to selectively control the ingress and egress of the plurality of real estate transaction documents and real estate transaction data to and from host server and enable at least one of the plurality of users to digital sign at least one selected electronic real estate transaction document.

According to another aspect of this embodiment, the encrypted data storage provides a secure symmetric-key encryption using 256-bit encryption keys for encrypting the real estate transaction data and the plurality of electronic real estate transaction documents.

According to another aspect of this embodiment, the at least one package is a plurality of packages. The plurality of packages including at least a contract negotiation package, a pre-approval package, appraiser package and title package. The host server is further configured to combine the plurality of packages into a closing package during closing of the real estate transaction for the buyer and seller to sign. According to another aspect of this embodiment, the real estate transaction documents comprise a sales contract, a mortgage document and at least one real estate closing document.

According to another aspect of this embodiment, the real estate transaction includes a plurality of stages, the plurality of stages including at least an appraisal stage, inspection stage, title search stage, loan approval stage and closing stage. The host server is further configured to restrict the accessibility of at least one of the plurality of electronic real estate documents based at least in part the stage of the real estate transaction.

According to another embodiment of the invention, a method for a real estate transaction system that includes at least one network data server and a host server is provided. Real estate transaction data associated with a real estate transaction is received. User data associated with a plurality of users associated with the real estate transaction is received. The plurality of users include at least a buyer and seller of real estate in the real estate transaction. At least one document package corresponding to a plurality of electronic real estate transaction documents is created based at least in part on the real estate transaction data and user data. Accessibility of each of the plurality of electronic real estate transaction documents for each of the plurality of users is determined based at least in part on the real estate transaction data and user data. Modifications made to the plurality of electronic real estate transaction documents by at least one of plurality of users is tracked throughout the real estate transaction. The modifications include at least digitally signing an electronic real estate transaction document and changing real estate transaction data associated an electronic real estate transaction document. The accessibility of at least one of the plurality of electronic real estate transaction documents is restricted after the at least one of the plurality of electronic real estate transaction documents have been digitally signed. Modified electronic real estate transaction documents are transmitted to the at least one network data server for storage.

According to one embodiment of this aspect, a first electronic real estate transaction document of the plurality of electronic real estate transaction documents is divided into a plurality of sections. The accessibility of each of the sections is based at least in part on the user. One of the plurality of users is granted access to a first section of the first electronic real estate transaction document and not granted access to a second section of the first electronic real estate transaction document. According to another aspect of this embodiment, the real estate transaction data is received from host server. The plurality of electronic real estate transaction documents and the real estate transaction data are processed. The plurality of real estate transaction documents and the real estate transaction data are encrypted. Encrypted data storage is provided for storing the plurality of real estate transaction documents and the real estate transaction data. The ingress and egress of the plurality of real estate transaction documents and real estate transaction data to and from host server is selectively controlled. At least one of the plurality of users is enabled to digital sign at least one selected electronic real estate transaction document.

According to another aspect of this embodiment, the encrypted data storage provides a secure symmetric-key encryption using 256-bit encryption keys for encrypting the real estate transaction data and the plurality of electronic real estate transaction documents.

According to another aspect of this embodiment, the at least one package is a plurality of packages. The plurality of packages includes at least a contract negotiation package, a pre-approval package, appraiser package and title package. The plurality of packages are combined into a closing package during closing of the real estate transaction for the buyer and seller to sign. According to another aspect of this embodiment, the real estate transaction documents comprise a sales contract, a mortgage document and at least one real estate closing document.

According to another aspect of this embodiment, the real estate transaction includes a plurality of stages. The plurality of stages include at least an appraisal stage, inspection stage, title search stage, loan approval stage and closing stage. The accessibility of at least one of the plurality of electronic real estate documents is restricted based at least in part the stage of the real estate transaction.

According to another embodiment of the invention, a real estate transaction system is provided. A host server in communication with the at least one network data server. The host server configured to receive real estate transaction data associated with a real estate transaction and receive user data associated with a plurality of users associated with the real estate transaction. The plurality of users include at least a buyer and seller of real estate in the real estate transaction. The host server is configured to create at least one document package corresponding to a plurality of electronic real estate transaction documents based at least in part on the real estate transaction data and user data, determine accessibility of each of the plurality of electronic real estate transaction documents for each of the plurality of users based at least in part on the real estate transaction data and user data, and track modifications made to the plurality of electronic real estate transaction documents by at least one of plurality of users throughout the real estate transaction. The modifications include at least digitally signing an electronic real estate transaction document and changing real estate transaction data associated an electronic real estate transaction document. The host server is configured to restrict the accessibility of at least one of the plurality of electronic real estate transaction documents after the at least one of the plurality of electronic real estate transaction documents have been digitally signed and transmit modified electronic real estate transaction documents to the at least one network data server for storage. The at least one network data server is configured to receive the real estate transaction data from host server, process the plurality of electronic real estate transaction documents and the real estate transaction data, encrypt the plurality of real estate transaction documents and the real estate transaction data and provide encrypted data storage for storing the plurality of real estate transaction documents and the real estate transaction data. The at least one network data server is configured to selectively control the ingress and egress of the plurality of real estate transaction documents and real estate transaction data to and from host server and enable at least one of the plurality of users to digital sign at least one selected electronic real estate transaction document.

According to another aspect of this embodiment, wherein a first electronic real estate transaction document of the plurality of electronic real estate transaction documents is divided into a plurality of sections. The accessibility of each of the sections is based at least in part on the user. One of the plurality of users is granted access to a first section of the first electronic real estate transaction document and not granted access to a second section of the first electronic real estate transaction document.

According to another aspect of this embodiment, the encrypted data storage provides a secure symmetric-key encryption using 256-bit encryption keys for encrypting the real estate transaction data and the plurality of electronic real estate transaction documents.

According to another aspect of this embodiment, the at least one package is a plurality of packages. The plurality of packages include at least a contract negotiation package, a pre-approval package, appraiser package and title package. the host server is further configured to combine the plurality of packages into a closing package during closing of the real estate transaction for the buyer and seller to sign.

According to another aspect of this embodiment, the real estate transaction documents comprise a sales contract, a mortgage document and at least one real estate closing document. According to another aspect of this embodiment, the real estate transaction includes a plurality of stages. The plurality of stages include at least an appraisal stage, inspection stage, title search stage, loan approval stage and closing stage. The host server is further configured to restrict the accessibility of at least one of the plurality of electronic real estate documents based at least in part the stage of the real estate transaction.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a web based real estate transaction system in accordance with the principles of the present invention;

FIG. 2A-2C is logic flow diagram of the web based real estate transaction system in accordance with the principles of the present invention;

FIG. 3 is a screenshot view of a new account screen display of the web based real estate transaction system in accordance with the principles of the present invention;

FIG. 4 is a screenshot of an existing account “Log in” screen of the web based real estate transaction system in accordance with the principles of the present invention;

FIG. 5 is a screenshot of a “Create new deal” screen of the web based real estate transaction system in accordance with the principles of the present invention;

FIG. 6 is a screenshot of a “Continue existing deal” screen of the web based real estate transaction system in accordance with the principles of the present invention;

FIG. 7 is a screenshot of a “Record deal” screen of the web based real estate transaction system in accordance with the principles of the present invention;

FIG. 8 is a screenshot of a “Create package” screen of the web based real estate transaction system in accordance with the principles of the present invention;

FIG. 9 is a screenshot of an “Add document(s) to package” screen of the web based real estate transaction system in accordance with the principles of the present invention;

FIG. 10 is a screenshot of a user's existing packages screen of the web based real estate transaction system in accordance with the principles of the present invention;

FIG. 11 is a screenshot of an “Edit package” screen of the web based real estate transaction system in accordance with the principles of the present invention;

FIG. 12 is a screenshot of an “invite users to share forms” screen of the web based real estate transaction system in accordance with the principles of the present invention;

FIG. 13 is a screenshot of an “invite users to sign forms” screen of the web based real estate transaction system in accordance with the principles of the present invention;

FIG. 14 is a screenshot of a “View documents” screen of the web based real estate transaction system in accordance with the principles of the present invention;

FIG. 15 is a screenshot of a “Fill forms in package” screen of the web based real estate transaction system in accordance with the principles of the present invention;

FIG. 16 is a screenshot of a “Notice of Right to Cancel” screen of the web based real estate transaction system in accordance with the principles of the present invention;

FIG. 17 is a screenshot of a “Package history of selected document” screen of the web based real estate transaction system in accordance with the principles of the present invention;

FIG. 18 is a screenshot of a “User uploads” screen of the web based real estate transaction system in accordance with the principles of the present invention; and

FIG. 19A-I is a logic flow diagram of the Key DMS process of the web based real estate transaction system in accordance with the principles of the present invention.

### DETAILED DESCRIPTION OF THE INVENTION

Before describing in detail exemplary embodiments that are in accordance with the present invention, it is noted that the embodiments reside primarily in combinations of apparatus components and processing steps related to conducting, completing and closing real estate transactions. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

The present invention advantageously provides an apparatus, system and method for conducting, completing and closing real estate transactions. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

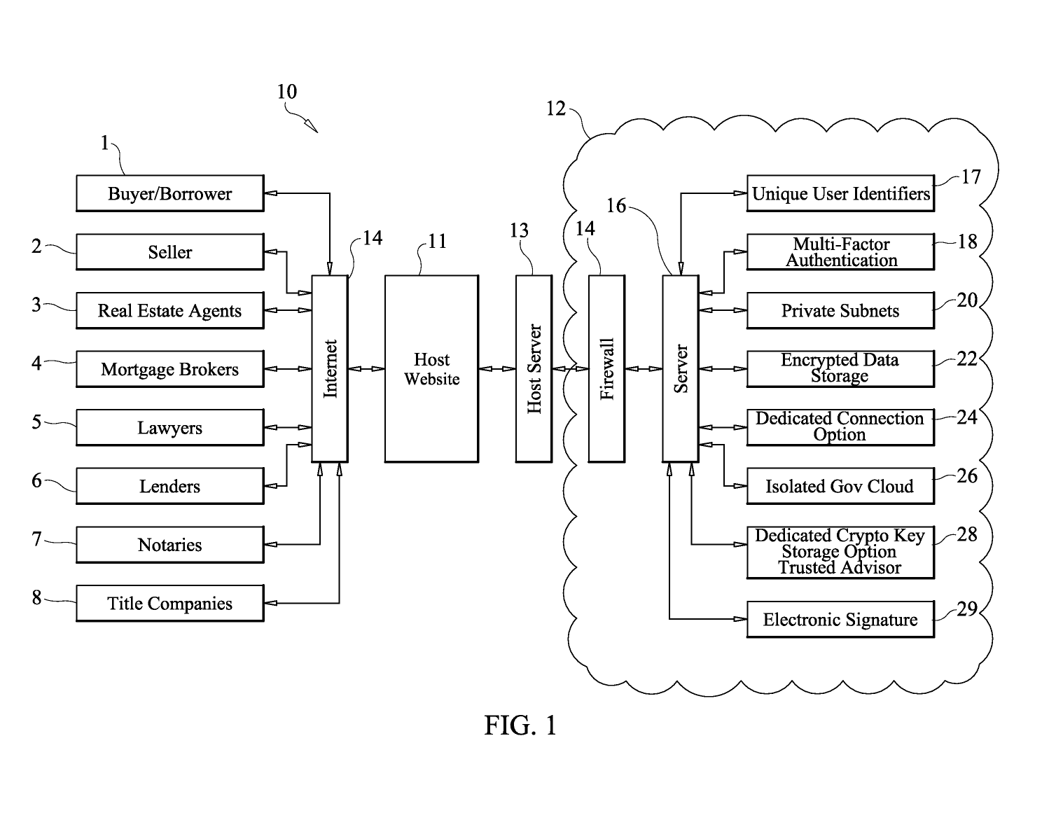

Referring now to drawing figures in which like reference designators refer to like elements there is shown in FIG. 1 an exemplary web based real estate transaction system that provides for paperless real estate transactions and closings is constructed in accordance with the principles of the present invention and designated generally as “10” or real estate transaction system 10. The web based real estate transaction system 10 includes a host server 13 that provides host website 11 to one or more devices (not shown) via a one or more networks (not shown), such as the Internet 9. As used herein computer, device, server and apparatus may include one or more communication interfaces, one or more processors and one or more memories for performing respective functions described herein. The one or more communication interfaces are configured to provide communications to devices in system 10 via one or more networks. The one or more processors may include one or more central processing units (CPUs) for performing functions as described herein. One or more memories may include non-volatile and volatile memory. For example, non-volatile memory may include a hard drive, flash memory, memory stick and the like. Also, volatile memory may include random access memory and others known in the art. The one or more memories store program instructions, which when executed by the processor, cause processor to perform functionality described herein.

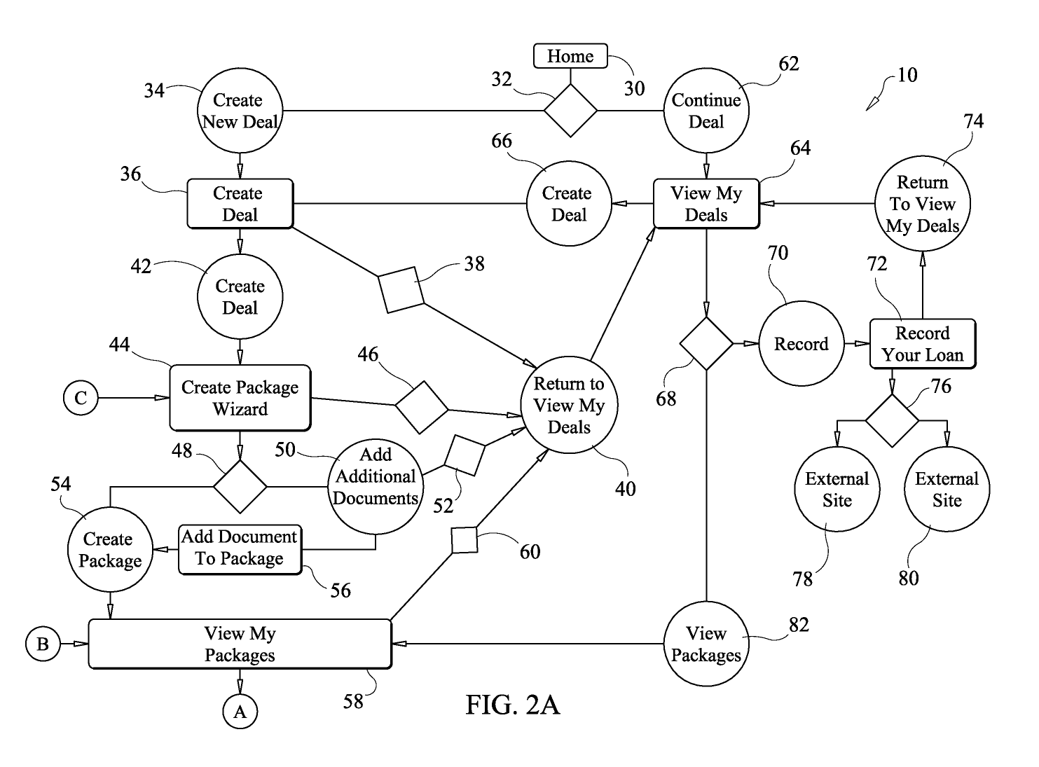

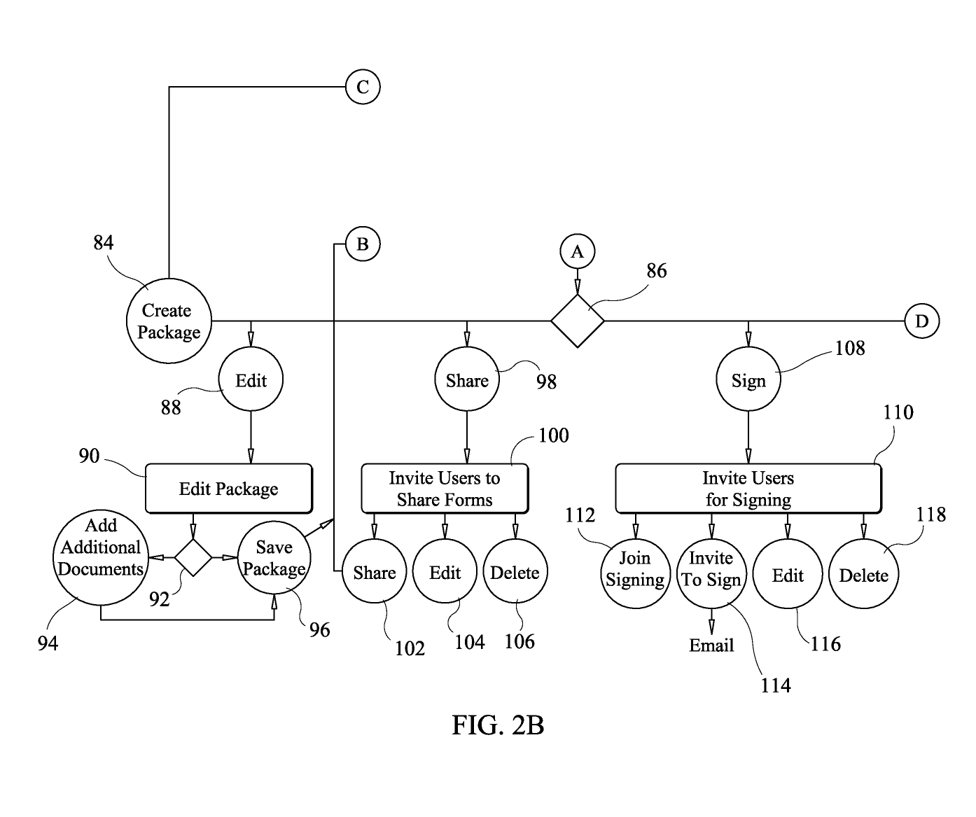

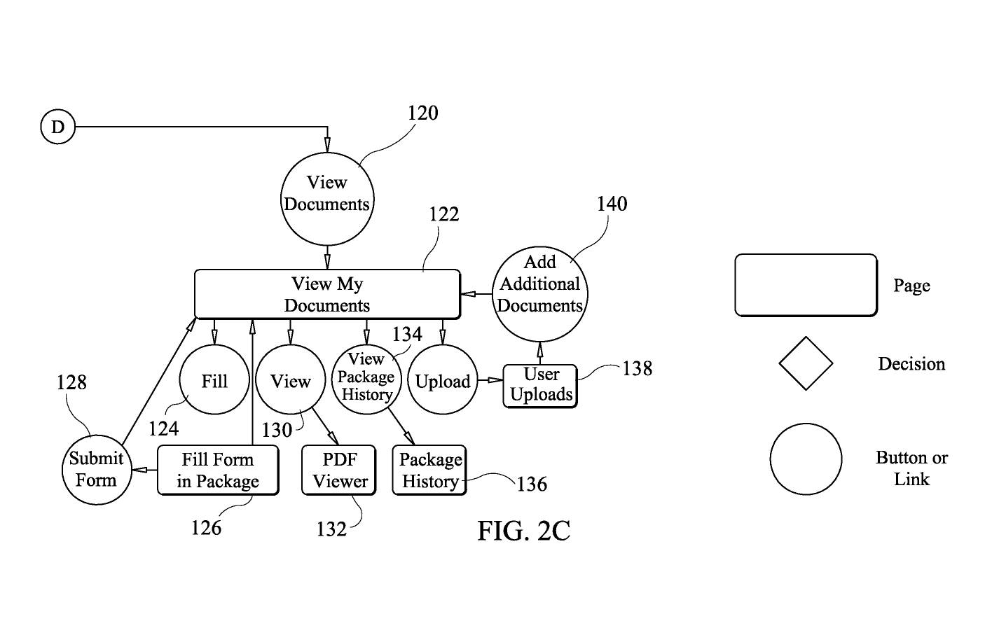

Host server 13 is configured to execute processor readable code of instructions, i.e. software, for performing the host server functions described in detail with respect to FIG. 2A-2C. Host server 13 communicates with at least one secured server 16 in a secured cloud 12 in which secured cloud 12 may include one or more built-in firewalls 14 that limit access to authorized participants involved in a real estate transaction. Secured cloud 12 may generate and provide digitized and encrypted real estate related documents, and may include electronic signature encryption software that enables selected participants to securely sign predetermined documents electronically. Secured cloud 12 may track and store all activity for each document, allow selected third party participants to view and participate in the transaction without having signing authority, and archive all documents and document activity in encrypted data storage. Secured cloud 13 may be one or more network servers such as secured sever 16.

Authorized participants communicate via host website 11 through individual computers 1-9, which may include buyer or borrower computer or device 1 (buyer 1), seller computer or device 2 (seller 2), real estate agents computer or device 3 (real estate agents 3), mortgage brokers computer or device 4 (mortgage brokers 4), lawyers computer or device 5 (lawyers 5), lenders computer or device 6 (lenders 6), notaries computer or device 7 (notaries 7) and title companies or agents computer or device 8 (title companies 8). System 10 may also include government entity computers or devices (not shown), such as Fannie Mae. System 10 electronically generates and provides the digitized documents required in the online real estate transaction, wherein the documents may include sales contracts, inspection reports, appraisals, surveys, loan pre-approval documents, mortgage applications, home insurance documents, title insurance documents and closing documents in secured cloud 12. Secured cloud 12 may provide secured access, built in firewalls 14, one or more server 16, unique user identifiers 17, multi-factor authentication 18, private subnets 20, encrypted data storage 22, dedicated connection options 24, isolated GovCloud 26, and, or dedicated crypto key storage options for trusted advisors 28, via one or more modules.

Continuing to refer to FIG. 1, all transactions are preferably conducted in secured cloud web 12. Secured cloud 12 provides secure access for users through customer access points, also called application program interface (API) endpoints, that allow secure HTTP or HTTPS access that establish secure communication sessions with web services providers, using SSL. The built-in firewalls 14 allow for controlled access by configuring built-in firewall rules from public to completely private and where access resides within a virtual private cloud (VPC) subnet, egress as well as ingress may be controlled.

Unique user identifiers 17 control the level of access users have to the web services infrastructure. Each user may have unique security credentials, eliminating the need for shared passwords or keys and allowing for role separation. Secured cloud 12 may provide multi-factor authentication 18 for use with web services accounts as well as individual user accounts. The private subnets 20 provide a virtual private cloud (VPC) that provides another layer of network security with private subnets and adding an Internet protocol security VPN tunnel between a user's home network and web services VPC. The encrypted data storage 22 automatically encrypts data and objects that are stored with a web service provider using Advanced Encryption Standard (AES) 256, which is a secure symmetric key encryption standard using 256-bit encryption keys. Dedicated connection option 24 allows users to establish a dedicated network connection to a web service provider that can be partitioned into multiple logical connections to enable access to both public and private IP environments with the web services cloud. The isolated GovCloud 26 provides additional security measures in order to comply with US regulations. Dedicated crypto key storage option 28 accommodates Hardware Security Module (HSM) appliances for cryptographic key storage, which provides a highly secure and convenient way to store and manage keys.

Continuing to refer to FIG. 1, electronic signature module 29 (electronic signature 29) may include embedded e-record audit trail capability or a comparable substitute. Electronic signature 29 produces a digitally signed e-record with an embedded audit trail. Electronic signature 29 captures the entire e-sign process, including appearance and order or web screens and documents, time spent on each page, emails, SMS text messages, voice signatures, images and videos and actions taken by signers. Electronic signature 29 can search, find and playback transaction evidence, export the evidence for retention purposes and output it to paper using PDF or HTML. All documents requiring signatures are electronically signed, authenticated, locked and archived.

Authorized signers receive an email with a link guiding them to and through the documents and signature process. Host website 11 may include a color-coded dashboard that provides red, yellow and green indicators for denoting deadlines for signatures. System 10 enables a notary to verify the identity of the buyer, and sign and seal electronically the closing documents. When the loan is closed, the transaction documents are stored in an encrypted security system, e.g., secured cloud 12, with multiple backups and made accessible for future reference. The participants are able to view, print and keep a copy of the real estate transaction package for their records. System 10 provides twenty four hour online access to transaction documents from contract to closing, including the instantaneous recording and secure storage upon completion.

Now referring to FIGS. 2A-2C, the real estate paperless transaction system 10 includes software that facilitates paperless real estate transactions and mortgage closings in compliance with the Uniform Transactions Act within a web environment for borrowers or buyers, sellers, brokers, real estate agents, lawyers, title companies and lenders. System 10 also electronically stores all closed loans and documents related to the real estate transaction that can be accessed to provide banks or other parties with confirmation of the transaction. The electronic documents may also be saved and stored as they are created.

Each professional, buyer or seller first registers on a home or register webpage 30. The registrant is prompted to enter all pertinent information, i.e., user data, that is stored for verification and contact purposes. The user will enter a username or email, set a password and then receive a confirmation email confirming the mail address. The user then enters the website to enter pertinent information, i.e., user data, that will dictate which forms they can fill out and where they can sign. For example, a user, e.g., buyer, may be granted to access to document and corresponding documents section that need to filled out by the buyer while access to other documents and corresponding document sections may be restricted, e.g., buyer may be restricted from accessing document and corresponding document sections that should be filled out by the seller, loan officer or other user, i.e., at least one document package corresponding to a plurality of electronic real estate transaction documents is created based at least in part on the real estate transaction data and user data in which accessibility of each of the plurality of electronic real estate transaction documents by each of the plurality of users is determined based at least in part on the real estate transaction data and user data.

They may also be required to sign a document releasing the website host 11 provider from any liability. Once registered, the user may create a new deal (Block 34) or continue a previous deal (Block 36) and select any electronic documents from a document library to create a package (Block 44). The document library may be stored in secured cloud 12 and may store all documents, including documents related to refinance, purchase, title, appraisal and bank mortgage. When a document is selected, a webpage appears with questions corresponding to sections in the document as dictated by the document. For example, the questions that appear in the webpage may be rephrased questions corresponding to original questions or language in the selected document, may match the questions or language in the selected document or may both rephrase and quote language from the document. A view of the document may be provided for reference by the user if they are unfamiliar with the document.

Any information entered into the electronic document or form can be saved in secured cloud 12 for later access and completion. If the user is making a purchase, they will have access to related documents, such as sales contracts, mortgage applications, pre-approvals and disclosures. If the user selects the option for refinancing, the same document options are made available, except for a sales contract. The user may be prompted to add additional documents (Block 48). If the user selects to add additional documents 50, the documents will be added to the package (Block 56). Once the user has filled in all necessary information and completed all necessary documents they create a package (Block 54) to be signed by all parties. The user is then able to view the package (Block 58). All information entered into the documents appears in a secured format such as portable document format (PDF) that cannot be changed. If any information in the document(s) needs to be changed, the user will change it in the web form and create a new package.

Continuing to refer to FIGS. 2A-2C, the user is next queried (Block 86) regarding the completion of the documents. The user has the option of making edits (Block 88), sharing the documents (Block 98), sending them to be signed (Block 108) or viewing documents (Blocks 120-122). The user can create a new package (Block 84), edit the package by adding additional documents, and saving the new package (Blocks 88-96). Third parties may also be invited to share forms, make edits or deletions (Blocks 98-106). When viewing documents, a form in the package may be required to be completed and submitted (Blocks 124-126). Documents are viewed with a pdf viewer and the package history may also be viewed (Blocks 130-136). Additional documents may be uploaded for viewing, as well (Blocks 138-140).

Continuing to refer to FIGS. 2A-2C, if the completed documents are ready for signature (Block 86), each authorized “signer” will receive an email with a link guiding them to where the documents are located and inviting them to sign (Blocks 110-114). The invited signer may edit or delete the document (Blocks 116-118), which then would be sent back to the sender. Throughout the process, the seller and third parties are able to observe and be involved even if they are not entering information into the documents or signing them. The document is then signed by digital signature. Once a document is digitally signed, the document is locked and archived with information about the person and all other secure pertinent information by digital signature. The digital signature provides all legal information required to prove who signed the document. If a user does not find a document needed, system 10 may include an upload functionality that will allow users to attach documents and the users will also be able to have them digitized for future use. If information needs to be changed in a signed document, the signature becomes invalid and a new package must be created for signature. All activity involving the creation of packages, the review of documents and the signature process along with documents are archived to provide proof of validity of the transaction. The archiving or tracking of all activity for each document throughout the transaction occurs is not user controlled, i.e., occurs in the background and is typically not noticeable by the users of system 10. The archiving or tracking functions continues to occur until a full final closing package is created and can be finalized with digital signatures from all parties included in the purchase and loan process.

Continuing to refer to FIGS. 2A-2C, a user can view their document package to determine if it is completed or before recording (Block 82). Once the package is completed and electronically signed by all necessary parties, the notary electronically signs and notarizes the documents in the package authenticating the signatures. The notary will have an account and set up their signature with a seal and verification number. After the package is notarized, it is sent electronically to the loan originator who submits for a title and appraisal. The originator then will submit electronically to the lender for approval. Once approved, the originator prepare for closing by creating a package for all document to be electronically signed. When the loan is ready to be closed, a closing package is created and sent electronically to all involved parties. A notary will be able to sign and seal electronically to verify the identity of the borrower. All parties are authenticated and given their own digital signature to use for each transaction. They will be authenticated upon signing into the digital signature software from email. The user is able to continue a deal that isn't completed (Block 62) until it is completed, view pending or completed deals and record documents and loans (Blocks 64-80).

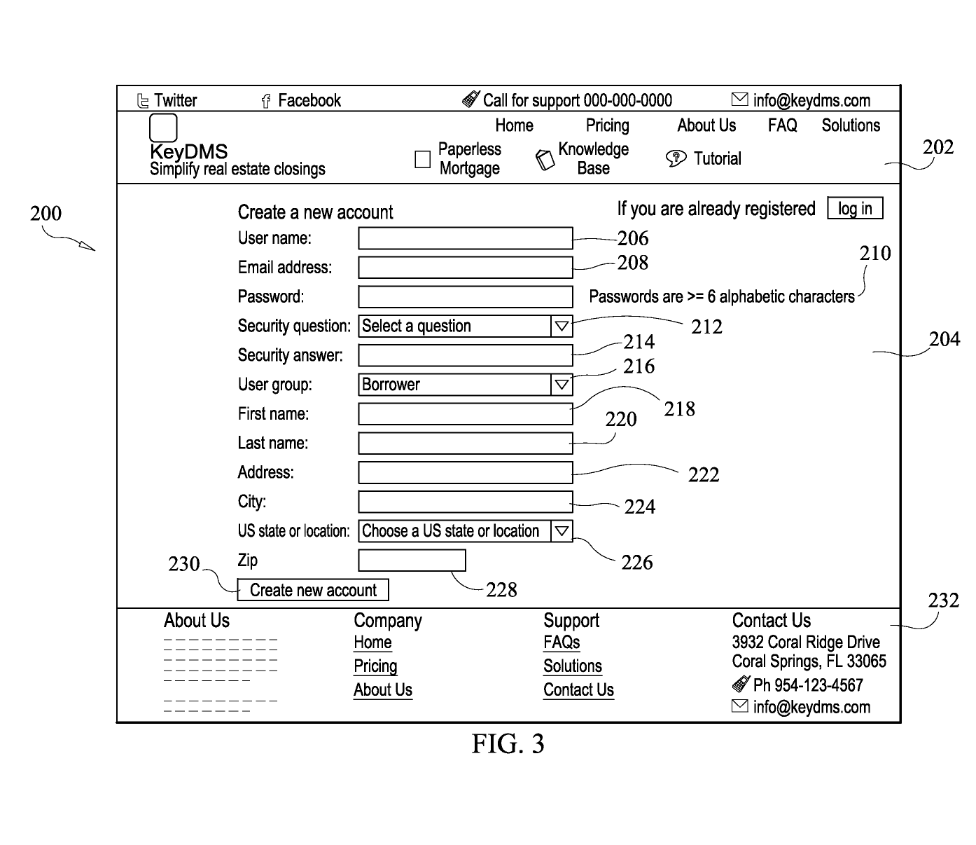

Now referring to FIG. 3, the real estate transaction system 10 includes a “new account” and “log in” page 200, generally referenced as a home page. This page includes a header 202 that provides links to a “Home” page, “Pricing” page, “About us” page, “FAQ” page, “Solutions” page, “Paperless Mortgage” page, “Knowledge Base” page and “Tutorials” page. The home page 200 includes a “Log in” link if the user is already registered and not creating a new account. The home page 200 also includes a plurality of “Create a new account” active fields for entering requested information to establish a new account, such as User name 206, E-mail address 208, Password 210, Security question 212, Security answer 214, User group, i.e. buyer, seller, agent, etc. . . . 216, First name 218, Last name 220, Address 222, City 224, location 226, Zip 228, “Create new account” link 230 and footer 232 with links to all other pages. This page enables a user to create a new account or be linked to a “log in” page. The flow process for creating new deals or packages is shown in FIG. 2A.

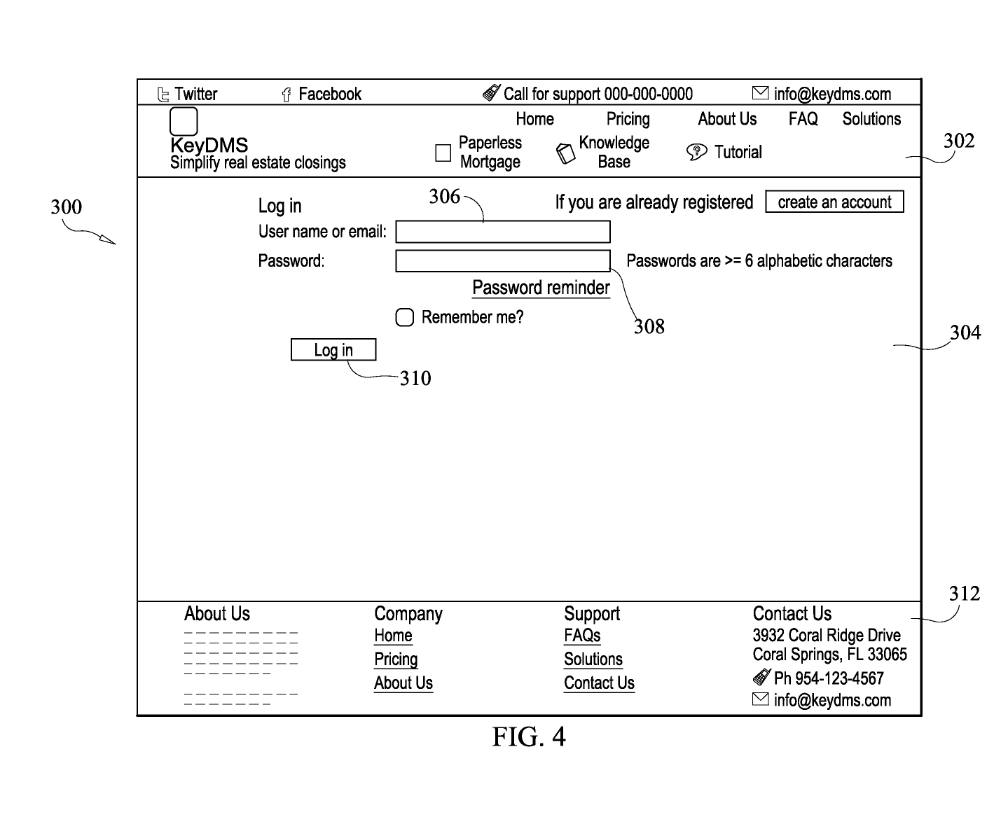

Now referring to FIG. 4, the real estate transaction system 10 includes a “log-in” page 300 for users with existing accounts. The log-in page 300 includes a header 302 with links to other pages in the server 16. The log-in page 300 also includes a “create an account” link for user's that are not previously registered. For existing or previously registered users, it has a “User name or email” field 306 for entering a name, “Password” field 308 for entering a password and “Log in” prompt for entering the user information. It also includes a footer field 312 for links to other pages in server 16.

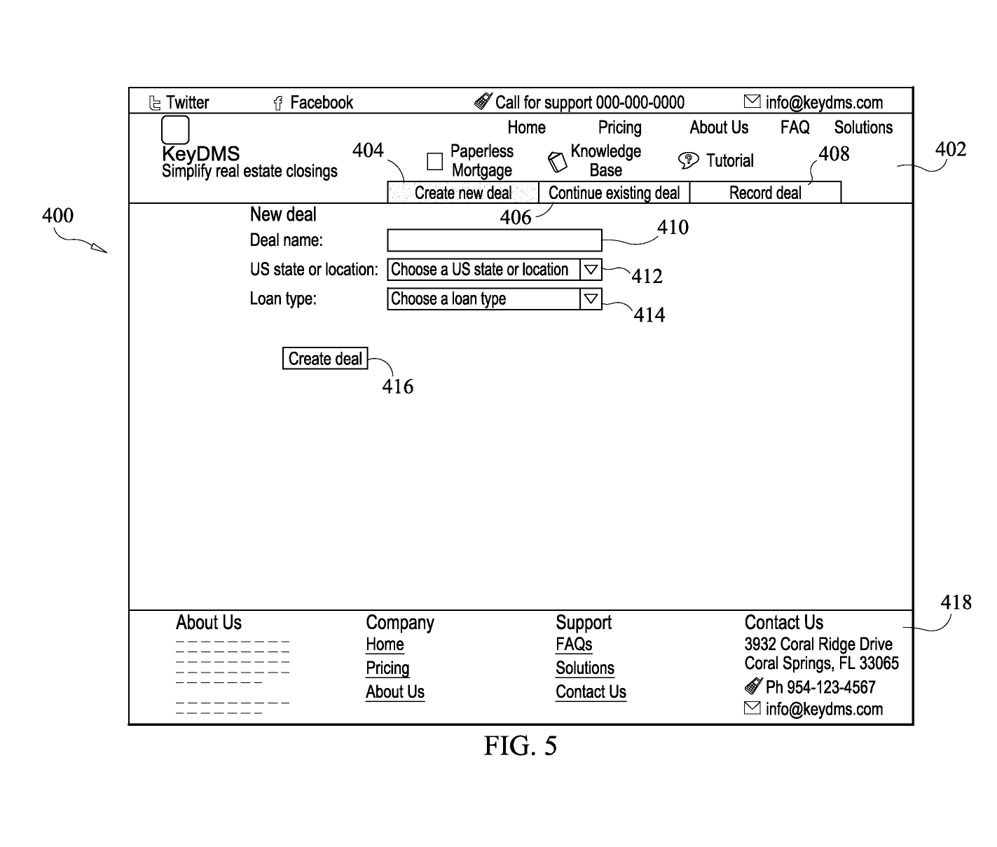

Now referring to FIG. 5, the real estate transaction system 10 includes a “New deal” page 400 for users setting up a new transaction. The “New deal” page 400 includes a header 402 with links to other pages in server 16. The “New deal” page 400 includes “Create new deal” link 404 for user's establishing a new deal, “Continue existing deal” link 406 for users that already have a transaction started and “Record deal” link 408 for users with completed transactions. The “New deal” page includes a “Deal name” field for entering an identifying deal name, a “US state or location” field 412 for the location of the property, a “Loan type” field 414 for entering the type of loan being used for the purchase of the property and a “Create deal” link 416 for submitting all the information entered with respect to the new deal. The “New deal” page also includes a footer field 418 for links to other pages in server 16. The flow process for creating and recording new deals or packages is shown in FIG. 2A.

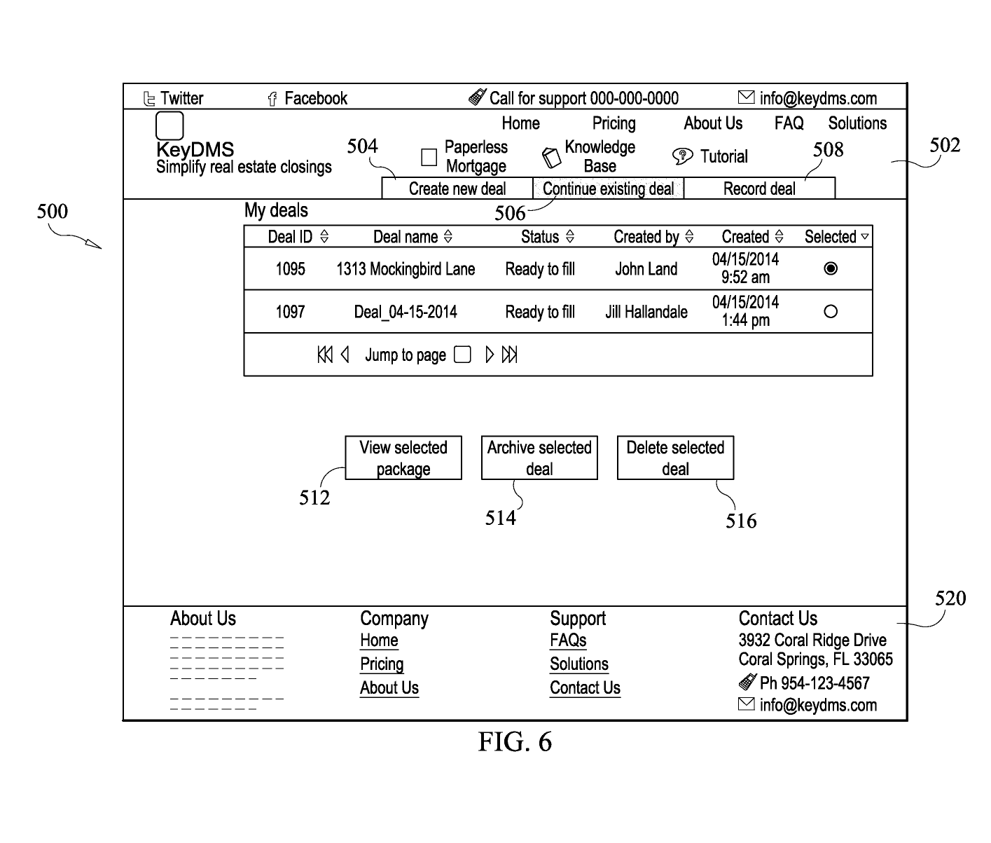

Now referring to FIG. 6, the real estate transaction system 10 includes a “My deals” or “Continue existing deal” page 500 for users with existing or currently pending deals. The “My deals” page 500 includes a header 502 with links to a “Create new deal” page 504, “Continue existing deal” page 506 or “Record deal” 508 page for linking to these other pages on the website. The “My deals” page 500 includes an existing deals table 510 of the user's deals. The page 500 also includes a “View selected package” link 512, “Archive selected deal” link 514 and “Delete selected deal” link 516. This page 500 further includes a footer 520 with links to other pages in server 16.

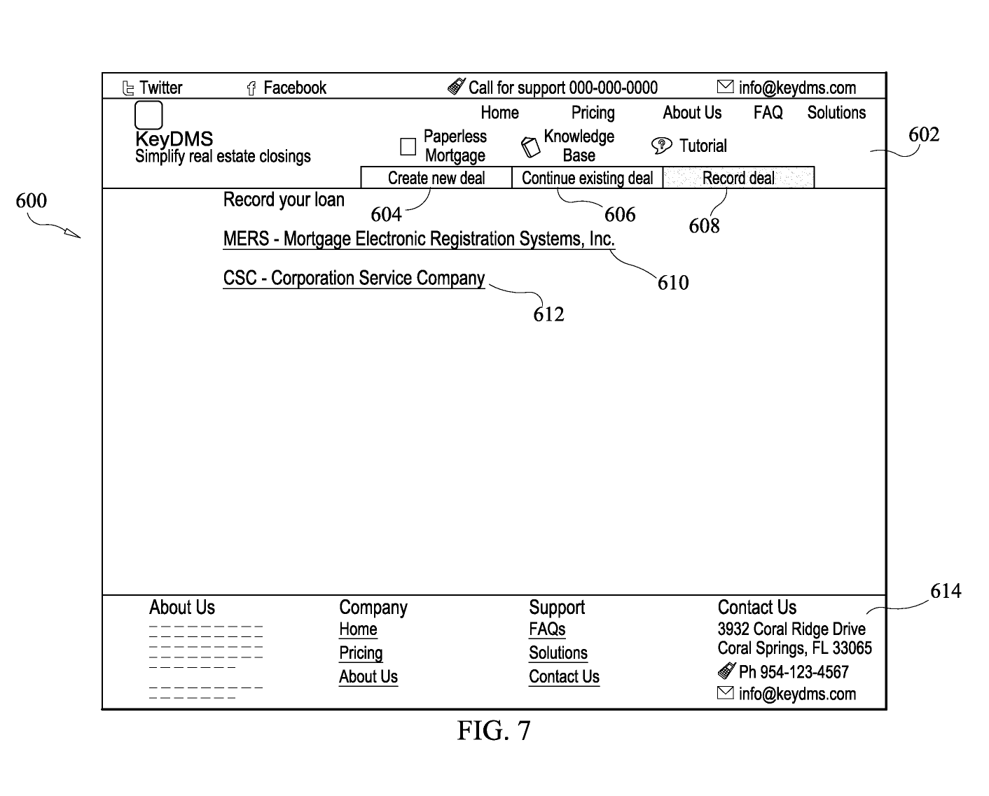

Now referring to FIG. 7, the real estate transaction system 10 includes a “Record deal” page 600 for users with completed deals. The “Record deal” page 600 includes a header 602 with links to a “Create new deal” page 604, “Continue existing deal” page 606 or “Record deal” 608 page for linking to these other pages in the server 16. The “Record deal” page 600 includes links 610-612 for recording loans. The page 600 also includes a footer 614 with links to the other pages in the server 16.

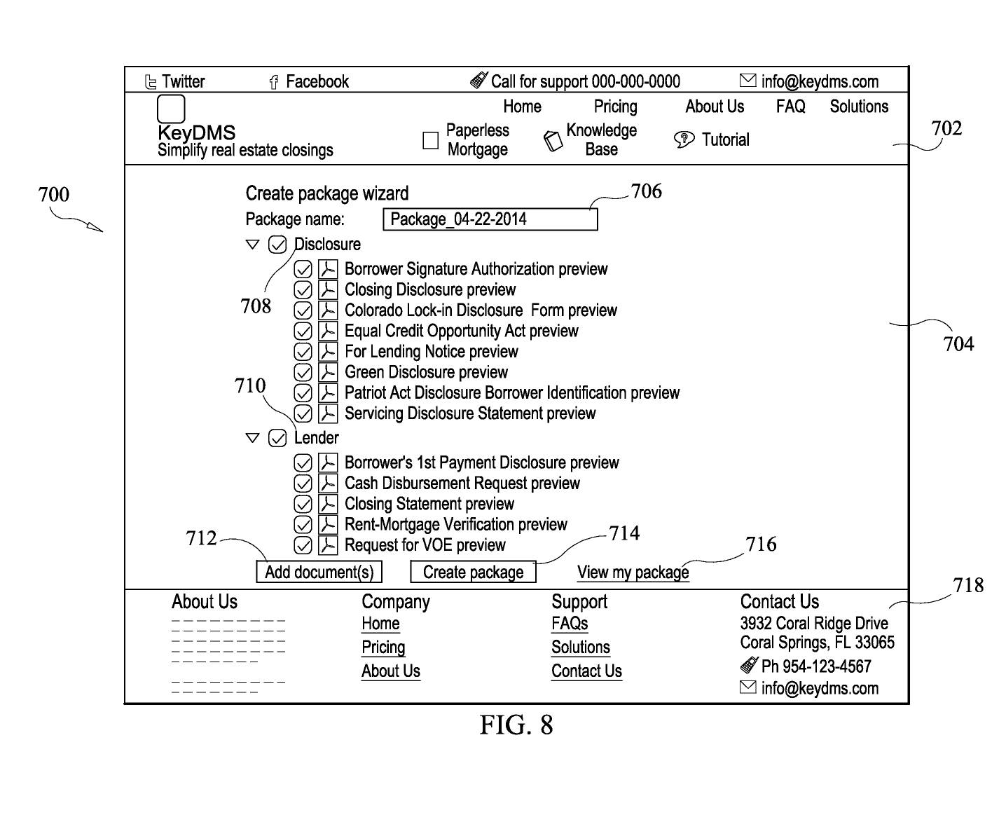

Now referring to FIG. 8, the real estate paperless transaction system 10 includes a “Create package wizard” page 700 for users with existing or currently pending deals. The “Create package wizard” page 700 includes a header 702 with links to other pages in the server 16. The “Create package wizard” page 700 includes a document page with a “Package name” link 706 for linking to or identifying an existing document package, a “Disclosure” link 708 for selecting and linking to selected documents, and a “Lender” link 710 for identifying or accessing lender related information. The page 700 also includes an “Add documents” 712 for adding or accessing documents not listed on the page 700, “Create packages” link 714 for creating document packages and a “View my packages” link 716 for viewing existing real estate document packages. This page 700 further includes a footer 718 with links to the other pages in the server 16.

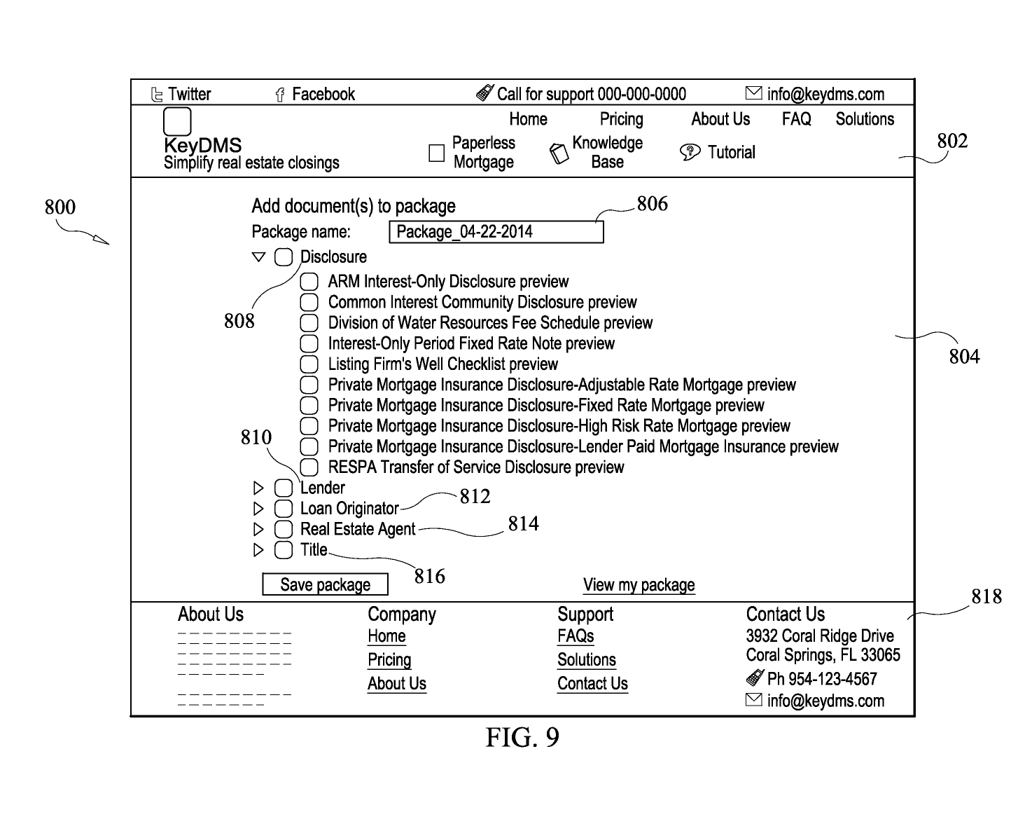

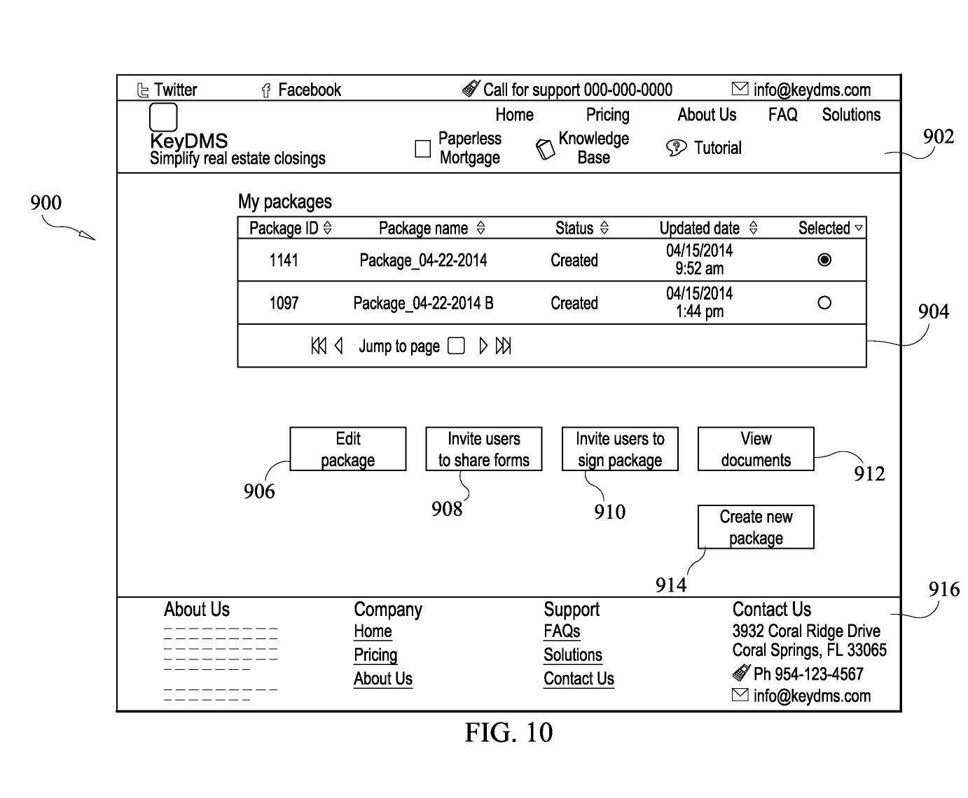

Now referring to FIG. 9, the real estate transaction system 10 includes an “Add document(s) to package” page 800 for users with existing or currently pending deals that desire to add missing or additional documents related to the transaction. The “Add document(s) to package” page 800 includes a header 802 with links to other pages in the server 16. The “Add document(s) to package” page 800 includes a document page with a “Package name” link or field 806 for identifying a list of documents for Disclosure 1008, Lender 810, Loan Originator 812, Real Estate Agent 814 and Title 816 with links for accessing and selecting documents to add to the package. This page 800 further includes a footer 818 with links to the other pages in the server 16.

Now referring to FIG. 10, the real estate transaction system 10 includes a “My packages” page 900 for users with existing or currently pending deals and document packages. The “My packages” page 900 includes a header 902 with links to other pages in server 16. The “My packages” page 900 includes a table with existing document packages of the user, an “Edit package” link 906 for editing a package, “Invite users to share forms” link 908 for sharing pending or existing documents with certain parties or third parties, “Invite users to sign package” link 910 for inviting requisite parties to execute necessary documents, and a “View documents” link for making all relevant documents available for review. This page 900 also includes a “Create new package” link 914 for creating a new package of documents when documents are changed. This page 900 further includes a footer 916 with links to the other pages in the server 16.

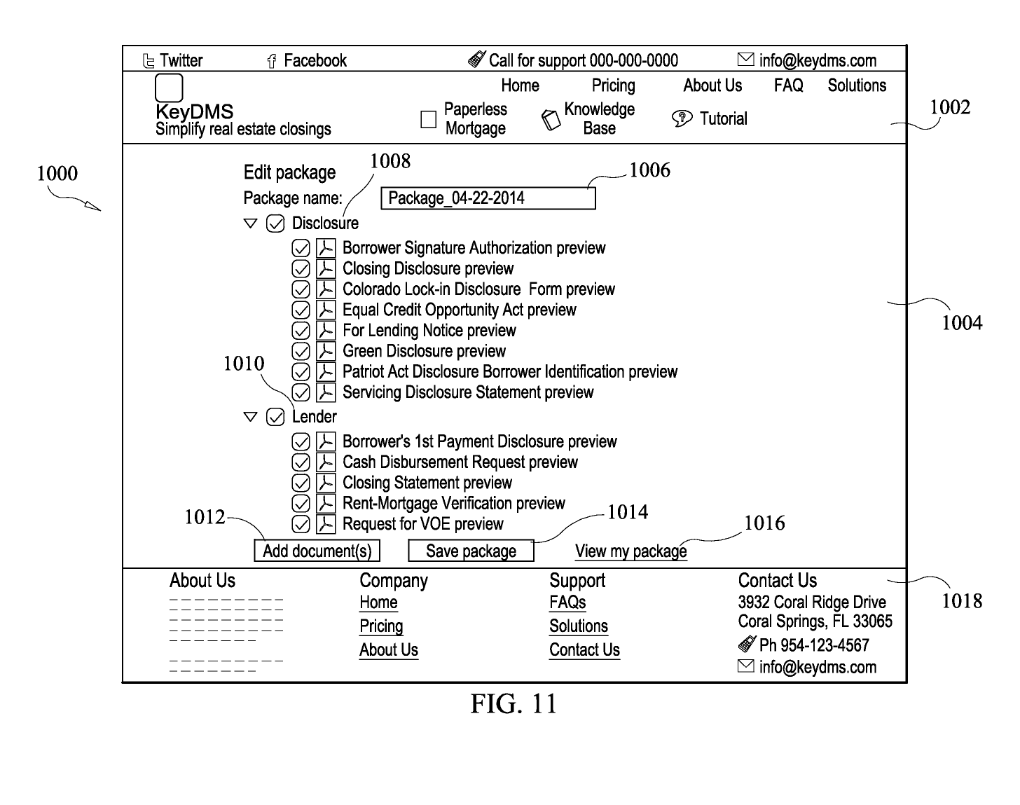

Now referring to FIG. 11, the real estate paperless transaction system 10 includes an “Edit package” page 1000 for users with existing or currently pending deals that desire to edit the document package. The “Edit package” page 1000 includes a header 1002 with links to other pages in server 16. The “Edit package” page 1000 has an edit window 1004 that includes a “Package name” link or field 1006 for linking to or identifying an existing document package, a “Disclosure” link 808 for selecting and linking selected disclosure documents and a “Lender” link 810 for selecting and linking selected lender related documents. The edit window 1004 includes “Add document(s)” link 1012, “Save package” link 1014 and “View my packages” link 1016. The “Add document(s)” link 1012 is clicked to add the selected documents and the “Save package” link 1014 is clicked to save the edited package. The “View my packages” link 1016 is clicked to view a user's packages and select one for viewing or editing, as shown in FIG. 11. Page 1000 further includes a footer 1018 with links to other pages on the server 16. The flow process for editing packages includes (Blocks 88-96) in FIG. 2B.

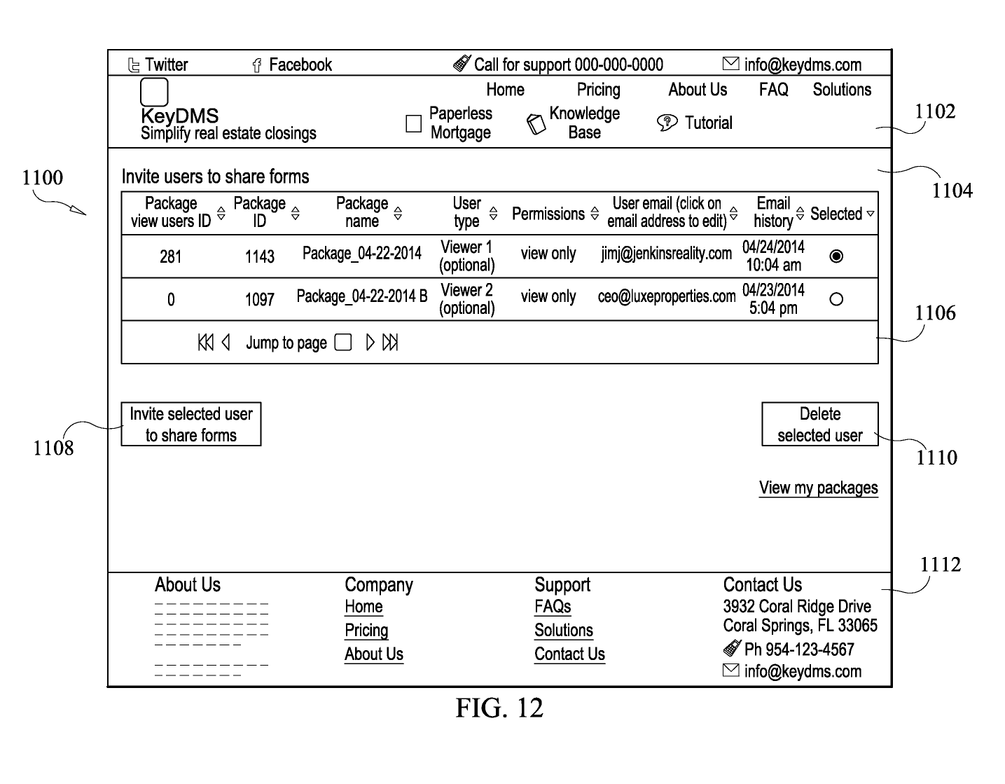

Now referring to FIG. 12, the real estate transaction system 10 includes an “Invite users to share forms” page 1100 for users to share selected documents in their packages. The “Invite users to share forms” page 1100 includes a header 1102 with links to other pages in server 16 and a main window 1104. A share forms browser 1106 is displayed in the main window 1104 identifying package view users ID, package IDs, package names, user types, permissions such as view only, user email address, email history and a select option for selecting particular users to share forms. Once selections are made, a “Invite selected user to share forms” link 1108 is clicked. To delete a selected user a “Delete selected user” link 1110 is clicked. Page 1100 further includes a footer 1112 with links to the other pages in the server 16. The flow process for inviting users to share forms includes Blocks 98-106 in FIG. 2B.

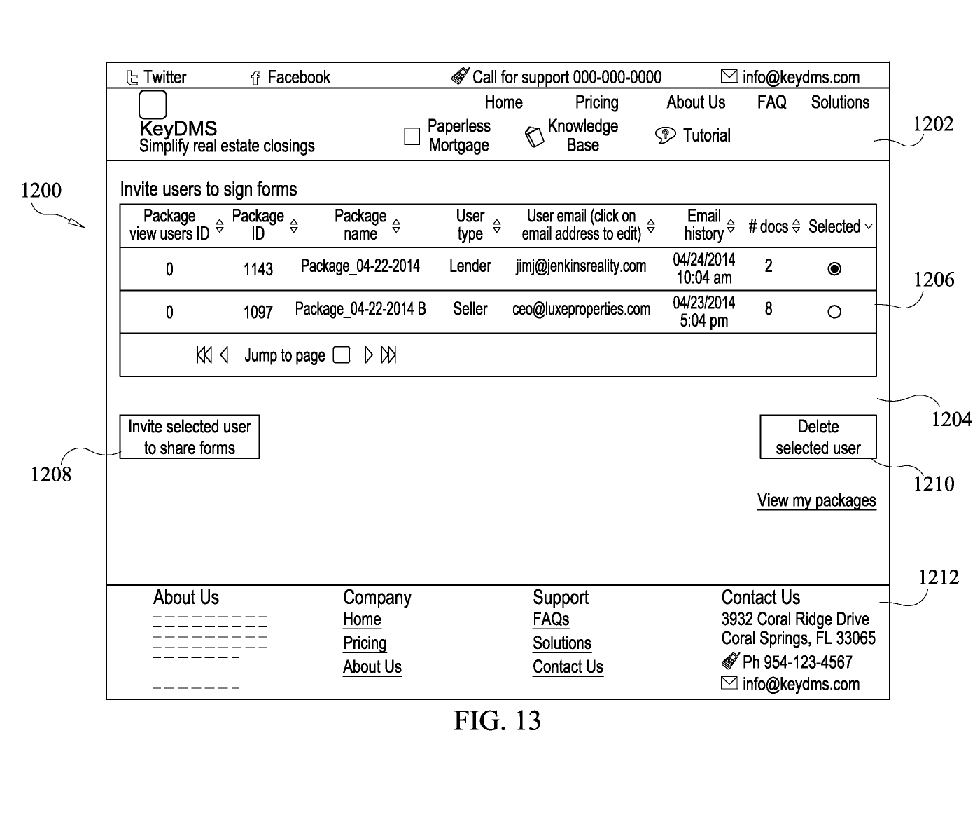

Now referring to FIG. 13, the real estate transaction system 10 includes an “Invite users to sign forms” page 1200 for users to invite other users to sign selected documents in their packages. The “Invite users to sign forms” page 1200 includes a header 1202 with links to other pages in the server 16 and a main window 1204. A sign forms browser 1206 is displayed in the main window 1204 identifying package view users ID, package IDs, package names, user types, permissions such as view only, user email address, email history, number of documents for each package and a select option for selecting particular users to sign forms. Once selections are made, a “Invite selected user to sign forms” link 1208 is clicked. To delete a selected user a “Delete selected user” link 1210 is clicked. Page 1200 further includes a footer 1212 with links to the other pages in the server 16. The flow process for inviting users to sign documents includes Blocks 108-118 in FIG. 2B.

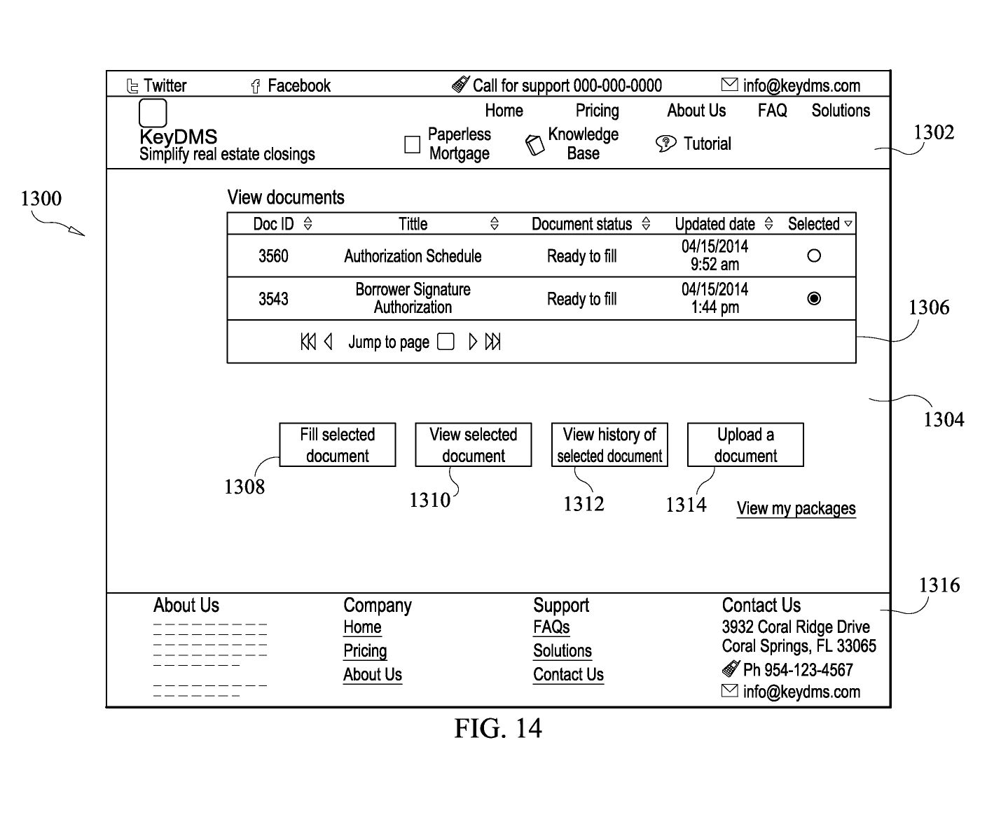

Now referring to FIG. 14, the real estate transaction system 10 includes a “View documents” page 1300 for users to view selected documents. The “View documents” page 1300 includes a header 1302 with links to other pages in the server 16 and a main window 1304. A view documents browser 1306 is displayed in the main window 1304 identifying documents available for viewing, titles of the documents, status of the documents such as “Ready to fill”, updated dates and a select option for selecting documents to view. Once a document is selected, the user has the option of filling in the selected document, viewing the selected document, viewing the history of the selected document or uploading the selected document. To fill in a selected document, a “Fill selected document” link 1308 is clicked. To view a selected document, a “View selected documents” link 1310 is clicked. To view the history of a selected document, a “View history of selected document” 1312 is clicked. To upload a selected document, an “Upload a document” link 1314 is clicked. To delete a selected user a “Delete selected user” link 1110 is clicked. Page 1100 further includes a footer 1112 with links to the other pages in the server 16. The flow process for viewing documents includes Blocks 120-140 in FIG. 2C.

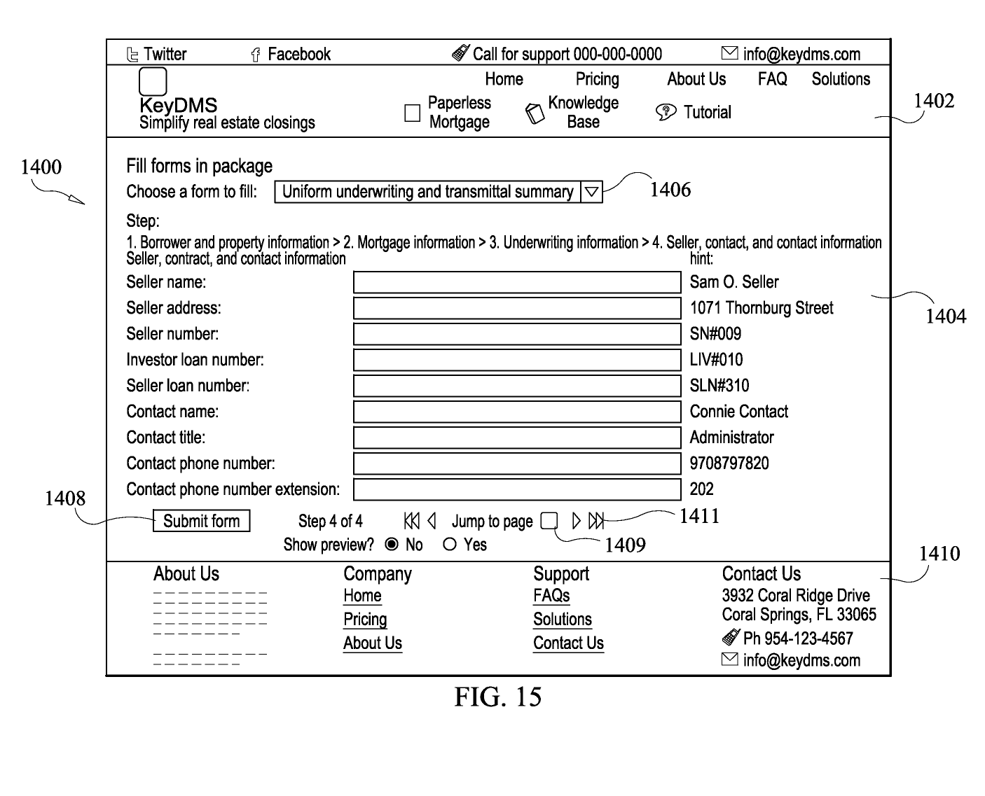

Now referring to FIG. 15, the real estate transaction system 10 includes a “Fill forms in package” page 1400 for filling in and completing documents in a package. The “Fill forms in package” page 1400 includes a header 1402 with links to other pages in the server 16. The “Fill forms in package” page 1400 includes a main window 1404 that includes a “Choose form to fill” link or field 1406 that includes a scrolled list of documents or forms available for completing and selecting. Once a form is completed and it is entered by clicking the “Submit form” link 1408. The main window 1404 includes a jump control 1409 that allows the user skip steps or return to steps by clicking the corresponding arrow links. It also includes first, previous, next and last arrow links 1411 for scrolling through the previous or next steps or advancing to the first or last step. The jump control 1409 can save much time and grief by allowing a user to pinpoint a step rather than clicking the first, previous, next or last arrows 1411. This page 1400 further includes a footer 1410 with links to other pages on the server 16.

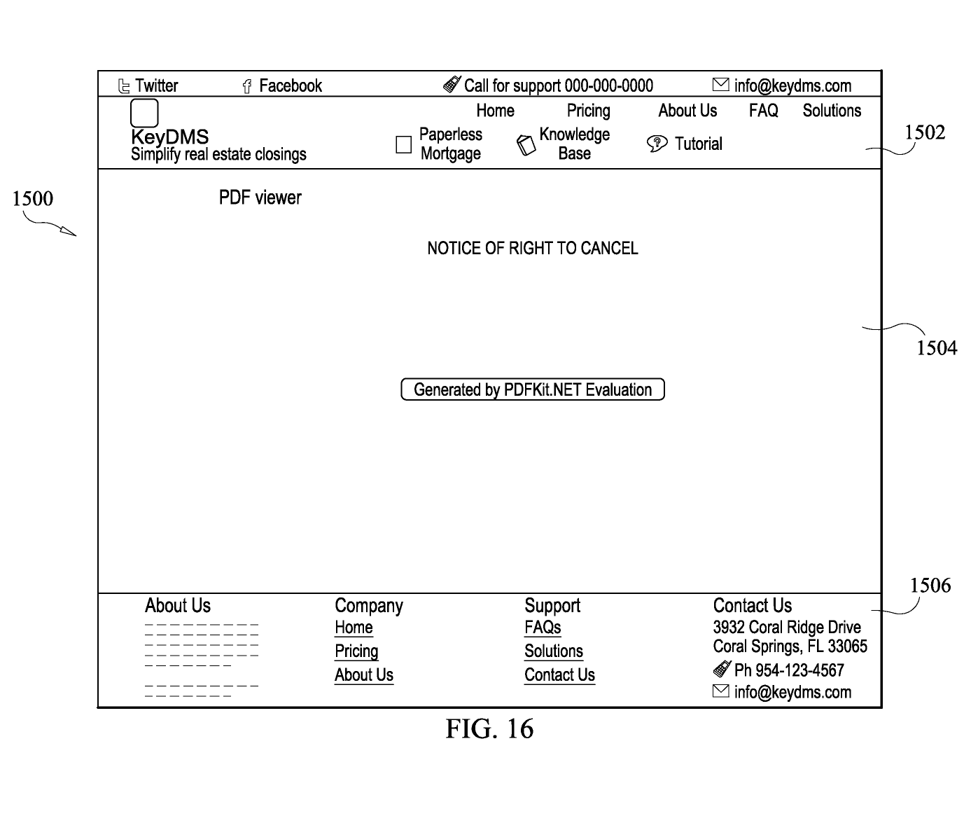

Now referring to FIG. 16, the real estate transaction system 10 includes a “Notice of Right to Cancel” page 1500 for users desiring to cancel a deal. The “Notice of Right to Cancel” page 1500 includes a header 1502 and footer 1506 with links to other pages in the server 16. A main window 1504 on the “Notice of Right to Cancel” page 1500 displays the notice and terms.

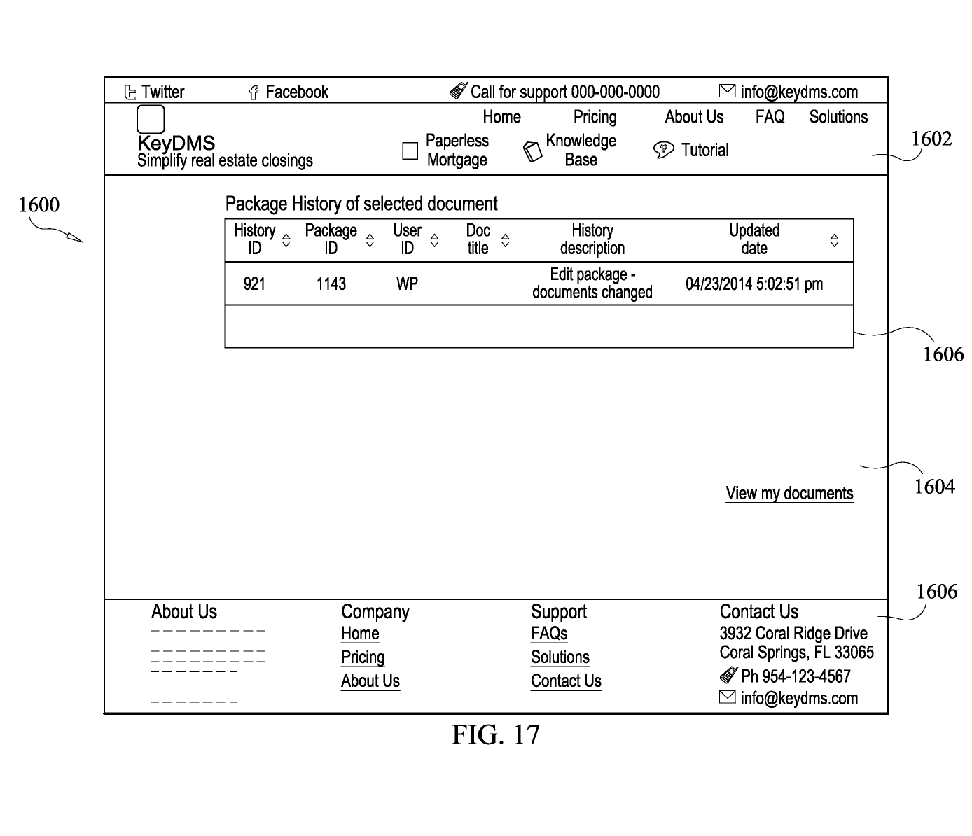

Now referring to FIG. 17, the real estate transaction system 10 includes a “Package History of selected document” page 1600 for displaying the history of selected or identified documents. The “Package History of selected document” page 1600 includes a header 1602 and footer 1608 with links to other pages in the server 16. A main window 1604 on the “Package History of selected document” page 1600 includes a browser 1606. The browser 1606 displays the History Id, Package ID, User ID, Doc title, History description, Package status, and Update date and includes a scroll feature.

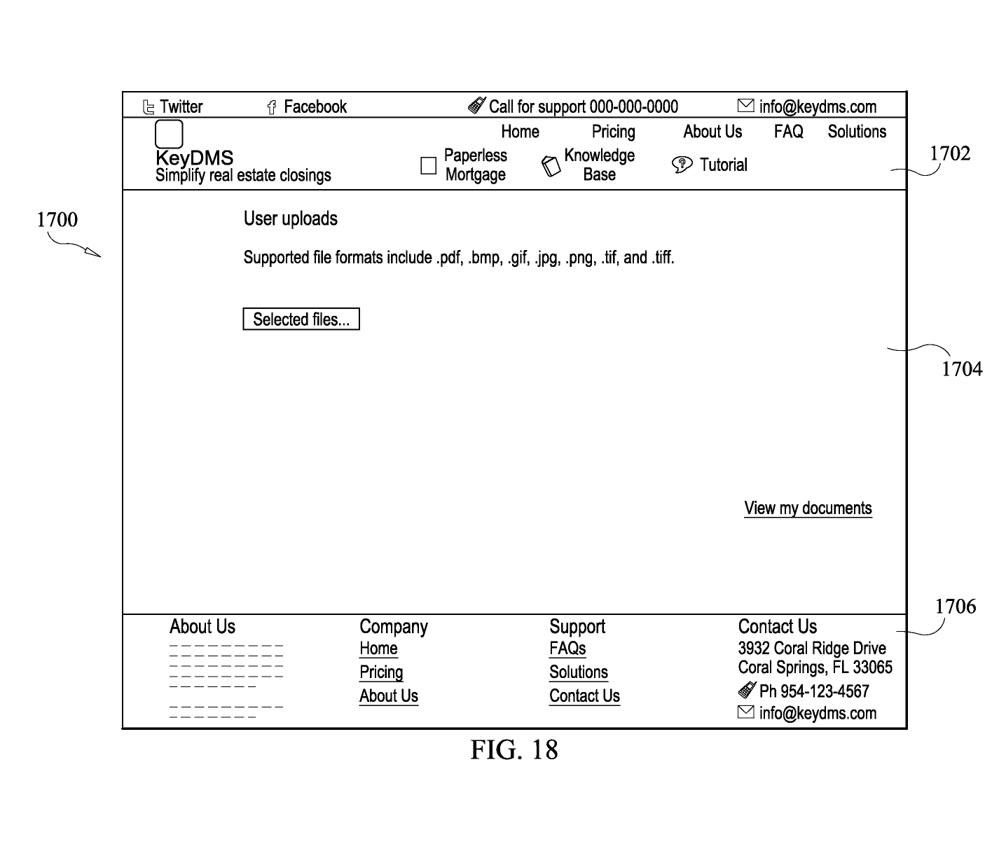

Now referring to FIG. 18, the real estate transaction system 10 includes a “User uploads” page 1700 for uploading selected or identified documents or packages. The “User uploads” page 1000 includes a header 1702 and footer 1706 with links to other pages in the server 16. A main window 1704 displays the selected file uploaded.

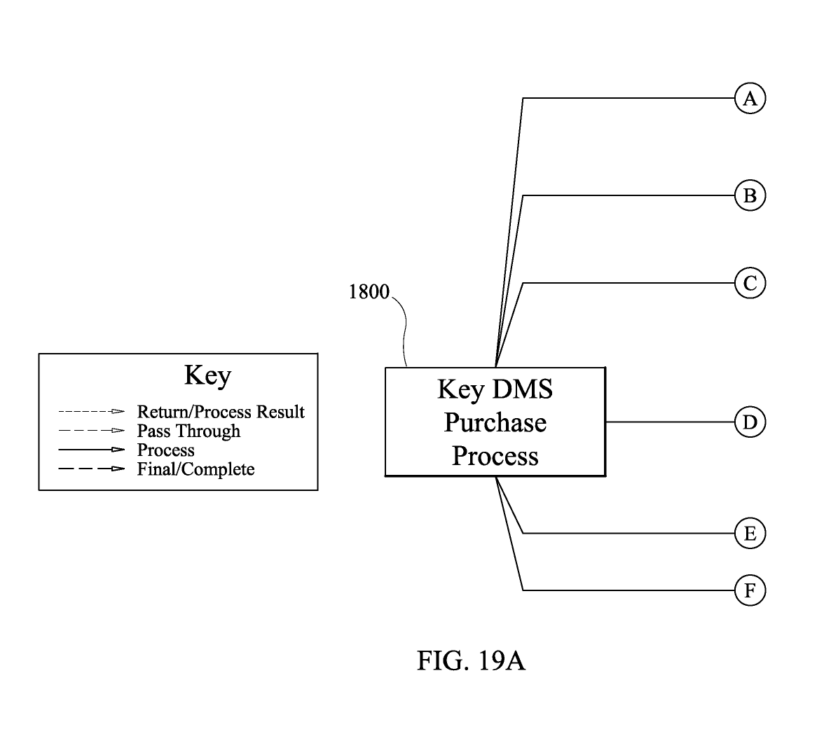

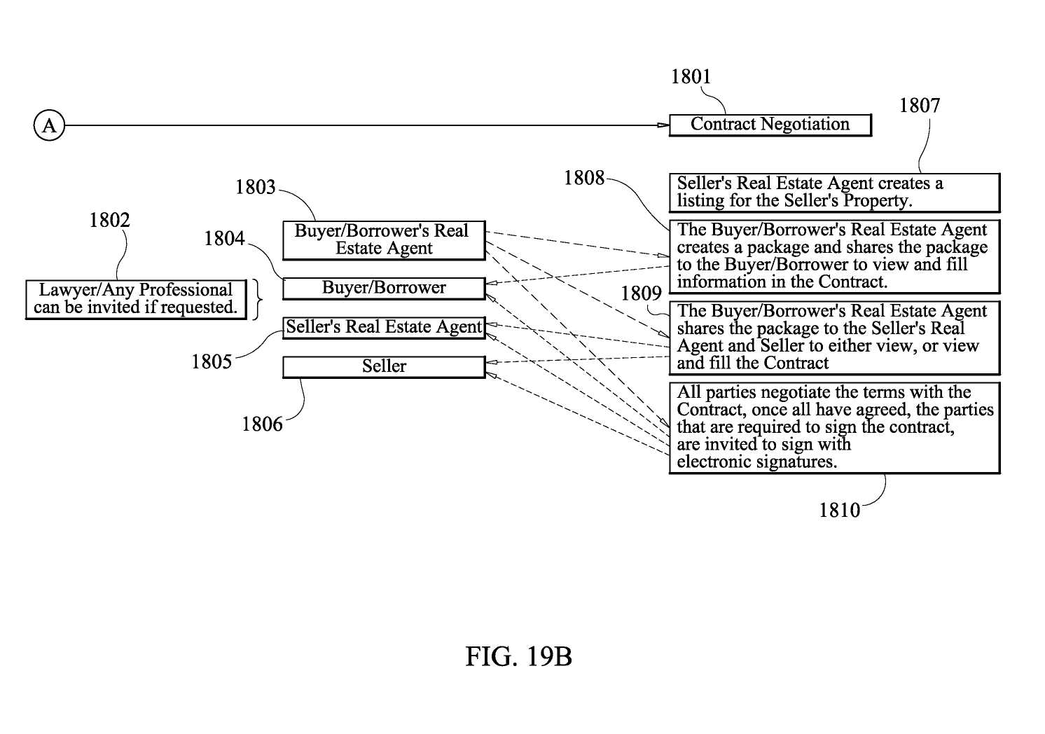

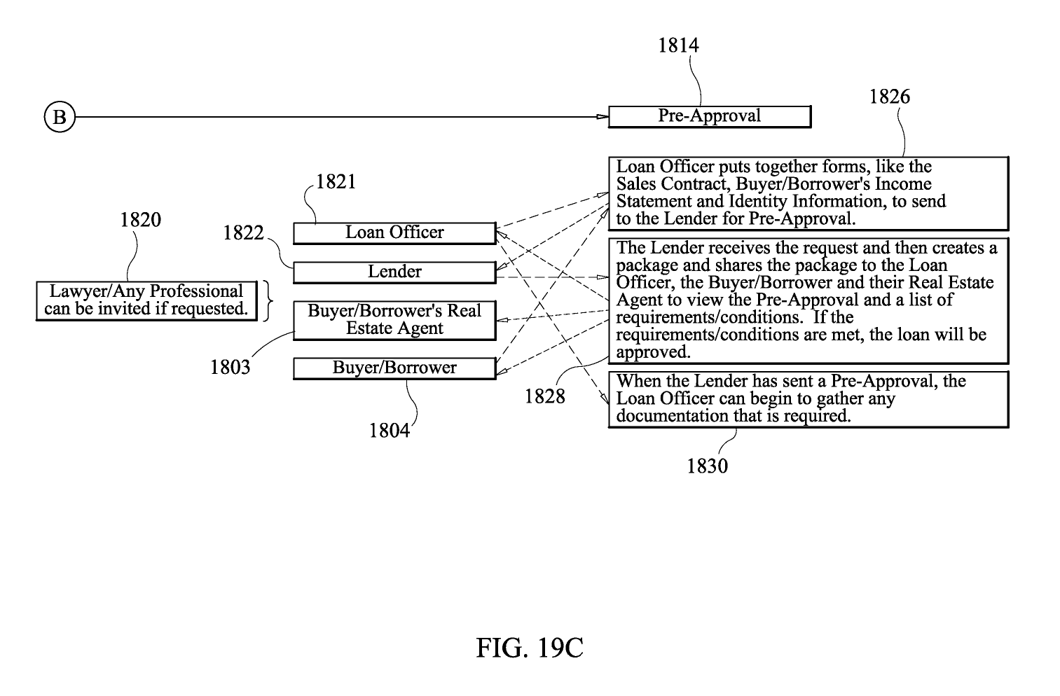

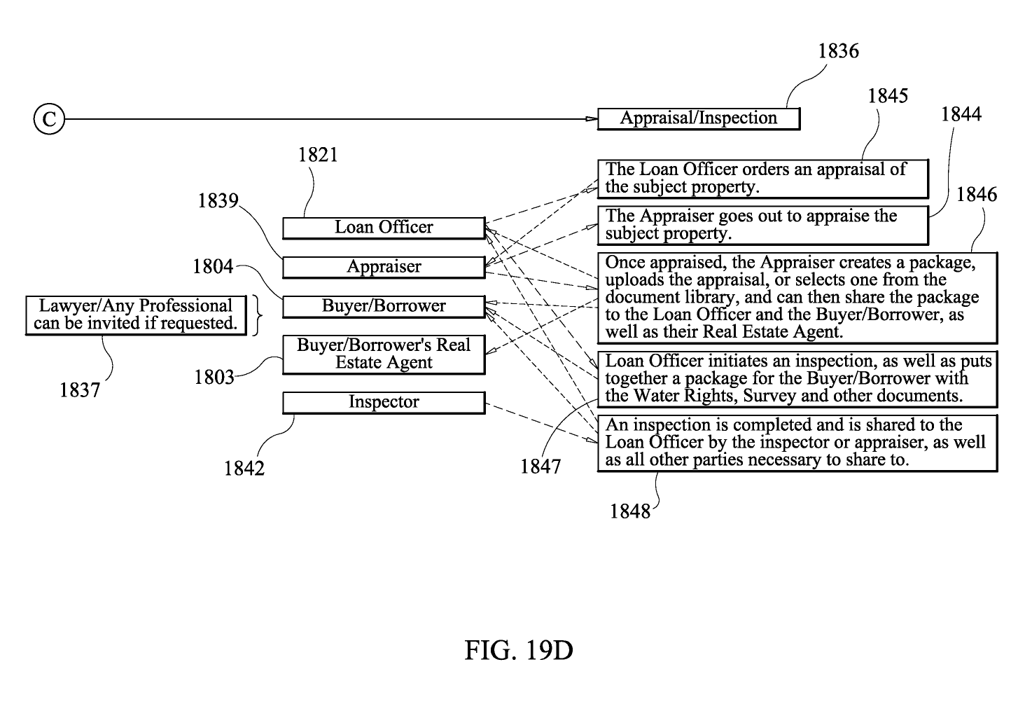

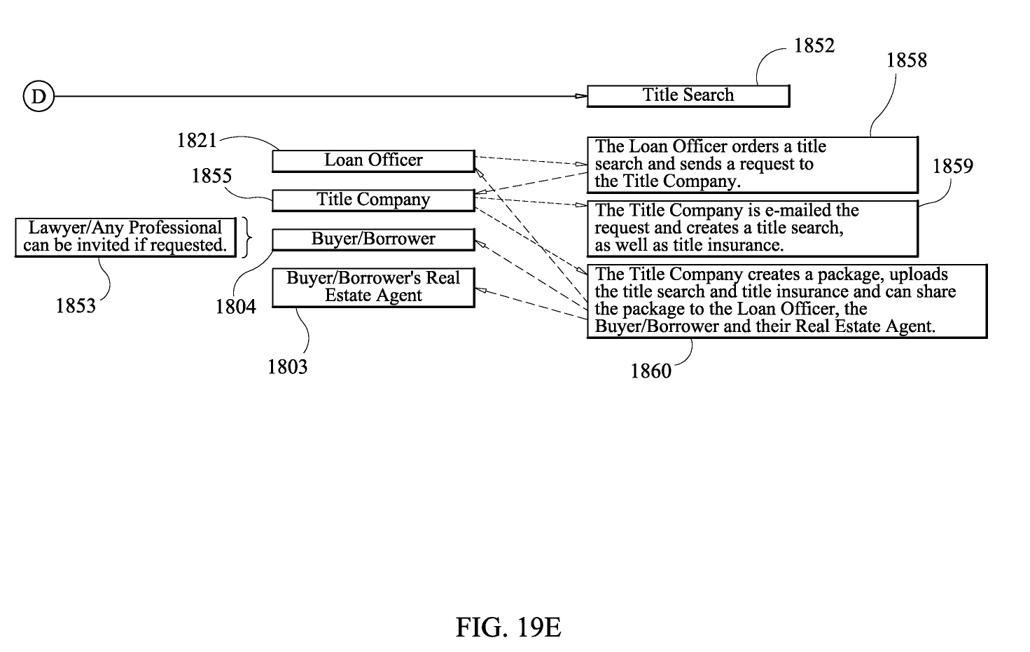

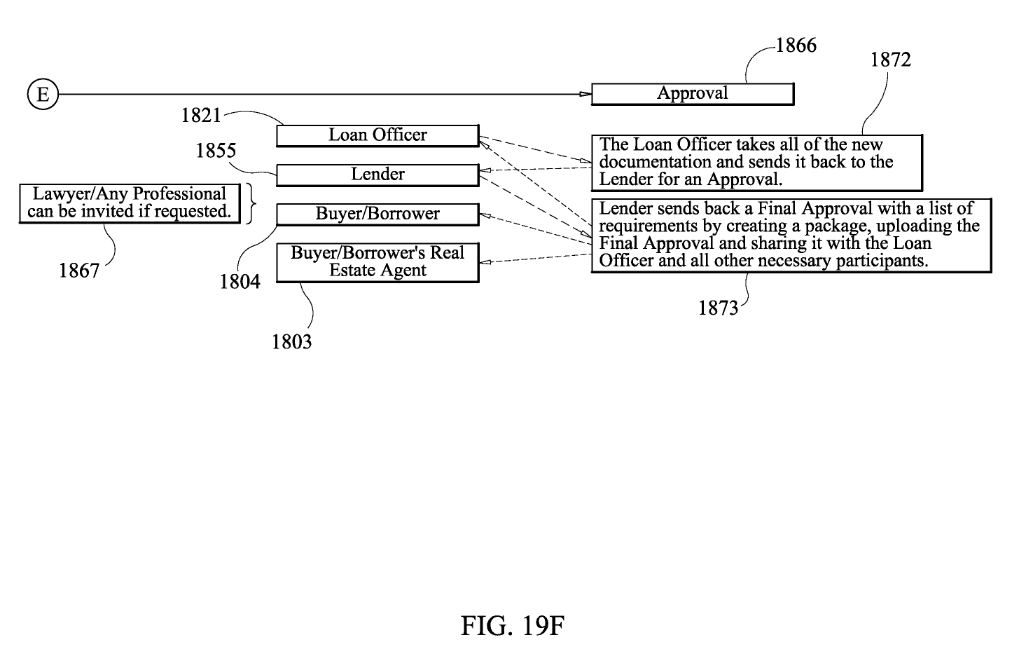

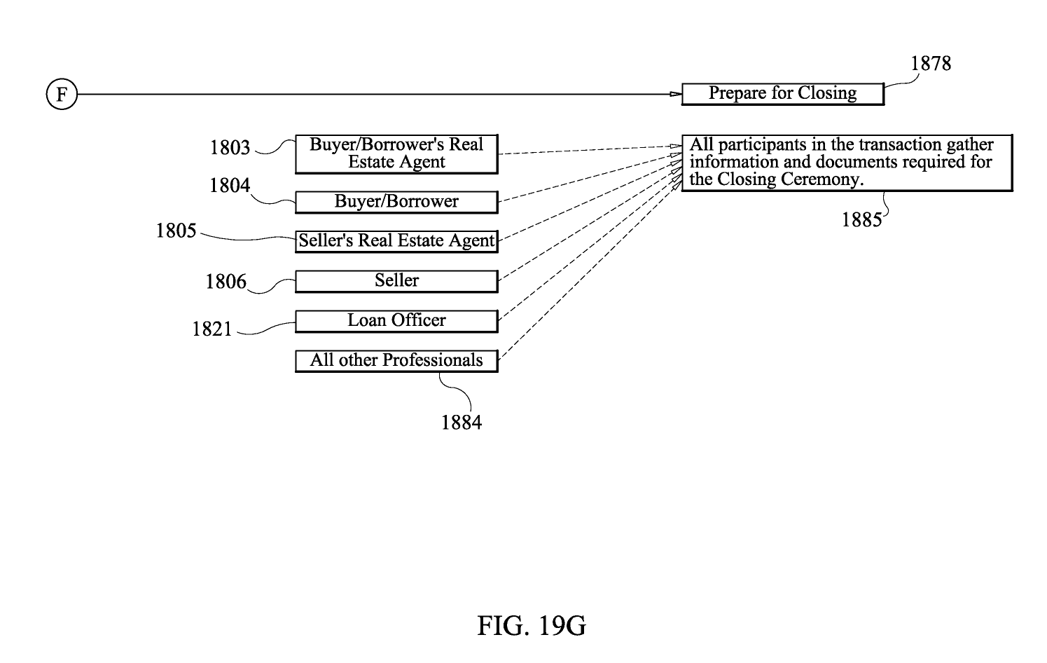

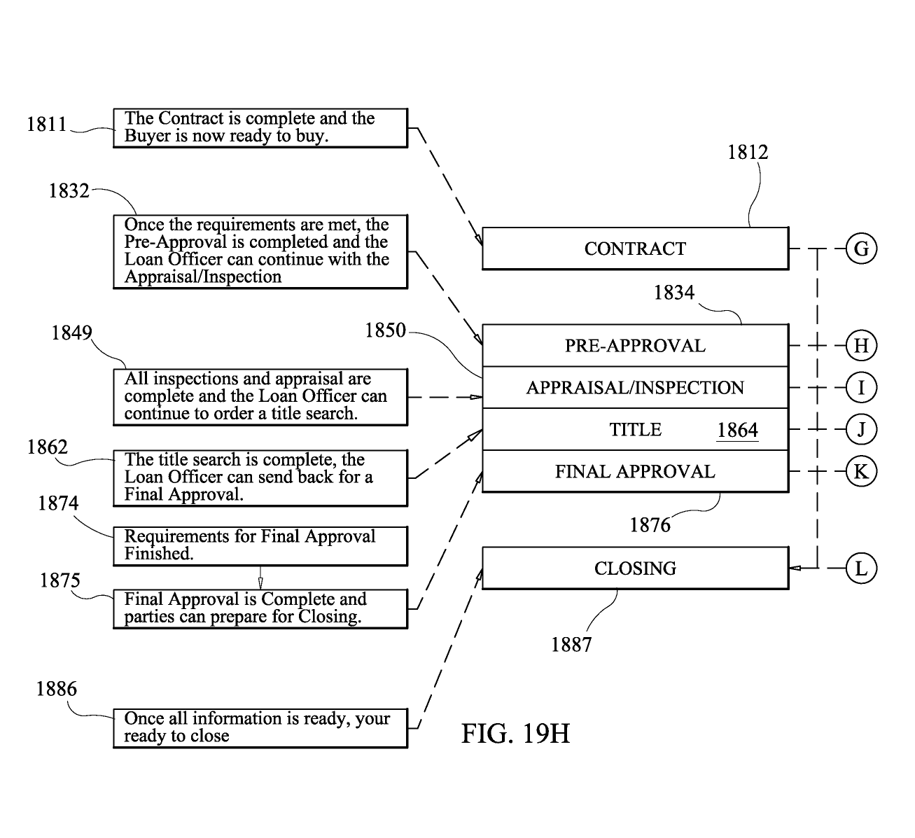

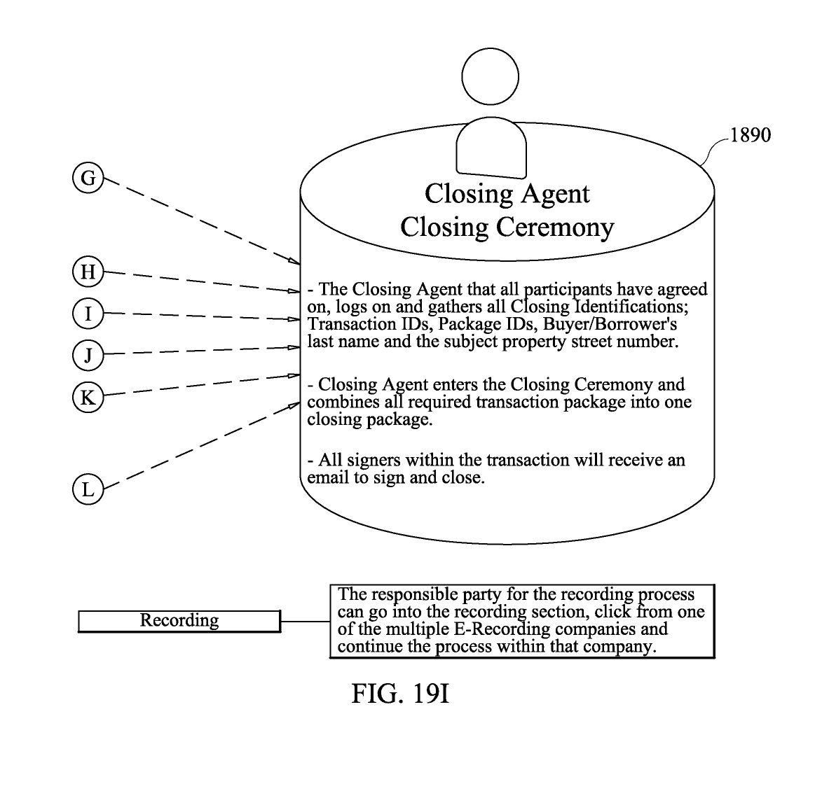

Now referring to FIG. 19A-I, the Key DMS process of real estate transaction system 10 includes a software based system real estate transaction process 1800 that facilitates remotely conducting a complete real estate transaction on a globally accessible computer network from contract negotiations to closing. The real estate purchase process/stage (Block 1800) begins with contract negotiations (Block 1801) where the lawyer or any professional may be invited if requested (Block 1802). In the contract negotiations (Block 1801), the parties that are involved and actively participate may include the buyer/borrower real estate agent (Block 1803), buyer/borrower (Block 1804), seller's real estate agent (Block 1805) and (Block seller 1806). To begin the process of Block 1800, the seller's real estate agent (Block 1805) creates a listing for the seller's property (Block 1807). The buyer/borrower's real estate agent (Block 1803) then creates a package, i.e., contract negotiation package, and shares the package with the buyer/borrower (Block 1804) to view and insert requested information into the contract 1808. Next, the buyer/borrower's real estate agent (Block 1803) shares the package with the seller's real estate agent and seller to view and insert requested information into the contract (Block 1809). Thereafter, the parties negotiate the terms in the real estate contract and, once agreed to, the parties required to sign the contract are invited to execute the contract with electronic signatures (Block 1810). At this point the real estate contract is completed and the buyer is ready to purchase (Block 1811).

Continuing to refer to FIG. 19A-I, the next step in the real estate transaction process of Block 1800 is the pre-approval stage for a loan or mortgage (Block 1814) where the lawyers or any professional may be invited if requested (Block 1820). In the pre-approval process (Block 1814), the parties that are involved and actively participate may include the loan officer (Block 1821), lender (Block 1822), buyer/borrower's real estate agent (Block 1803) and buyer/borrower (Block 1804). The loan officer (Block 1821) first compiles the real estate transaction forms, such as the sales contract, buyer/borrower's income statement and identify confirmation information and sends them to the lender (Block 1822) for pre-approval (Block 1826). The lender (Block 1822) receives the real estate transaction forms and request for a loan, creates a package, i.e., pre-approval package, and provides the package to the loan officer (Block 1821), the buyer/borrower (Block 1804) and their real estate agent (Block 1803) to review the pre-approval documents and a list of requirements or conditions (Block 1828). If the requirements or conditions are satisfied, the loan is approved (Block 1828). The lender (Block 1822) then sends the pre-approval to the loan officer (Block 1821) and the loan officer (Block 1821) gathers any other documents requested and required (Block 1830). Once the loan pre-approval requirements are met, the pre-approval process (Block 1814) is completed and the loan officer (Block 1821) can continue with the appraisal and inspection (Block 1832).

Continuing to refer to FIG. 19A-I, the next step in the real estate transaction process (Block 1800) is the appraisal and inspection process/stage (Block 1836) where lawyers and other professionals may be invited if requested (Block 1837). In the appraisal and inspection process (Block 1836), the parties that are involved actively participate may include the loan officer (Block 1821), appraiser (Block 1839), buyer/borrower (Block 1804), buyer/borrower's real estate agent (Block 1803) and inspector (Block 1842). The appraisal and inspection process (Block 1836) begins with the loan officer (Block 1821) ordering an appraisal of the real estate property being sold and purchased (Block 1843). The appraiser (Block 1839) then visits the property and conducts an appraisal of its value or worth (Block 1844). Once the property is appraised, the appraiser (Block 1839) creates a package, i.e., appraiser package, uploads the appraisal or selects one from the document library and then shares the package with the loan officer (Block 1821), buyer/borrower (Block 1804) and the buyer/borrower real estate agent (Block 1803). Thereafter, the loan officer (Block 1821) initiates an inspection and creates a package for the buyer/borrower (Block 1804) with water rights and other documents (Block 1847). The inspector then performs an inspection and provides the inspection report to the loan officer (Block 1821), appraiser (Block 1839) and, or all other parties requiring the inspection report (Block 1848). Once all inspections and the appraisal are completed, the loan officer (Block 1821) orders the title search (Block 1849).

Continuing to refer to FIG. 19A-I, the next step in the real estate transaction process (Block 1800) is the title search process/stage (Block 1852), where lawyers and other professionals may be invited if requested (Block 1853). In the title search process (Block 1852), the parties that are involved and actively participate may include the loan officer (Block 1821), title company (Block 1855), buyer/borrower (Block 1804) and buyer/borrower real estate agent (Block 1803). The title search process (Block 1852) begins with the loan officer (Block 1821) ordering a title search by sending a request to the title company (Block 1858). The title company (Block 1858) is emailed the request and creates a title search, as well as title insurance (Block 1859). The title company (Block 1858) then creates a package, i.e., title package, uploads the title search and title insurance and may share the package with the loan officer (Block 1821), the buyer/borrow (Block 1804) and the buyer/borrower real estate agent (Block 1803) (Block 1860). When the title search is completed, the loan officer (Block 1821) requests a final approval (Block 1862).

Continuing to refer to FIG. 19A-I, the next step in the real estate transaction process (Block 1800) is the approval process/stage (Block 1866), where lawyers and other professionals may be invited if requested (Block 1867). In the approval process (Block 1866), the parties that are involved and actively participate may include the loan officer (Block 1821), (Block lender 1822), buyer/borrower (Block 1804) and buyer/borrower's real estate agent (Block 1803). The approval process (Block 1866) is initiated when the loan officer (Block 1821) takes all the new documentation and sends it back to the lender (Block 1822) for approval (Block 1872). The lender (Block 1822) creates and sends a package with a final approval with a list of requirements and conditions, uploading the final approval and sharing it with the loan officer (Block 1821) and all other necessary participants (Block 1873). The requirements for final approval are then completed and the parties may prepare for closing (Block 1874-1875).

Continuing to refer to FIG. 19A-I, the next step in the real estate transaction process (Block 1800) is to prepare for closing, i.e., closing stage (Block 1878) where all necessary participants participate, including the buyer/borrower real estate agent (Block 1803), buyer/borrower (Block 1804), seller's real estate agent (Block 1805), seller (Block 1806), loan officer (Block 1821) and all other professionals invited, and gather information and documents required for the closing (Block 1885). Once all information is compiled, the parties proceed to closing (Block 1886). At closing, all documents are presented including the contract, pre-approval, appraisal/inspection, title and final approval (Block 1812). The closing is then commenced (Block 1887). At the closing, the closing agent confirms that all participants have agreed to terms and are logged on and then gathers all closing identifications, transaction identifications, packages identifications, buyer/borrower's name and the subject property and street number (Block 1890). The closing agent enters the closing ceremony and combines all required transaction packages into one closing package (Block 1890). For example, the multiple created packages, e.g., contract negotiation package, pre-approval package, appraiser package and title package, are combined into a closing package for closing of the real estate transaction for the buyer and seller to sign. All signers within the transaction receive an email to sign and close. The entire real estate transaction process (Block 1800) or parts thereof may be recorded where the responsible party for the recording process can go into the recording section, click from one of the multiple e-recording companies and continue the process within that company (Block 1892-1894).

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A real estate transaction system including at least one network data server, comprising:
a host server in communication with the at least one network data server, the host server configured to:
receive real estate transaction data associated with a real estate transaction;
receive user data associated with a plurality of users associated with the real estate transaction, the plurality of users including at least a buyer and seller of real estate in the real estate transaction;
creating at least one document package corresponding to a plurality of electronic real estate transaction documents based at least in part on the real estate transaction data and user data;
determine accessibility of each of the plurality of electronic real estate transaction documents for each of the plurality of users based at least in part on the real estate transaction data and user data;
track modifications made to the plurality of electronic real estate transaction documents by at least one of plurality of users throughout the real estate transaction, the modifications include at least digitally signing an electronic real estate transaction document and changing real estate transaction data associated an electronic real estate transaction document;
restrict the accessibility of at least one of the plurality of electronic real estate transaction documents after the at least one of the plurality of electronic real estate transaction documents have been digitally signed; and
transmit modified electronic real estate transaction documents to the at least one network data server for storage.

2. The system of claim 1, wherein a first electronic real estate transaction document of the plurality of electronic real estate transaction documents is divided into a plurality of sections, the accessibility of each of the sections being based at least in part on the user, one of the plurality of users being granted access to a first section of the first electronic real estate transaction document and not granted access to a second section of the first electronic real estate transaction document.

3. The system of claim 1, wherein the at least one network data server is configured to:
receive the real estate transaction data from host server;
process the plurality of electronic real estate transaction documents and the real estate transaction data;
encrypt the plurality of real estate transaction documents and the real estate transaction data;
provide encrypted data storage for storing the plurality of real estate transaction documents and the real estate transaction data;
selectively control the ingress and egress of the plurality of real estate transaction documents and real estate transaction data to and from host server; and
enable at least one of the plurality of users to digital sign at least one selected electronic real estate transaction document.

4. The system of claim 1, wherein the encrypted data storage provides a secure symmetric-key encryption using 256-bit encryption keys for encrypting the real estate transaction data and the plurality of electronic real estate transaction documents.

5. The system of claim 1, wherein the at least one package is a plurality of packages, the plurality of packages including at least a contract negotiation package, a pre-approval package, appraiser package and title package; and
the host server is further configured to combine the plurality of packages into a closing package during closing of the real estate transaction for the buyer and seller to sign.

6. The system of claim 1, wherein the real estate transaction documents comprise a sales contract, a mortgage document and at least one real estate closing document.

7. The system of claim 1, wherein the real estate transaction includes a plurality of stages, the plurality of stages including at least an appraisal stage, inspection stage, title search stage, loan approval stage and closing stage; and
the host server is further configured to restrict the accessibility of at least one of the plurality of electronic real estate documents based at least in part the stage of the real estate transaction.

8. A method for a real estate transaction system including at least one network data server and a host server, the method comprising:
receiving real estate transaction data associated with a real estate transaction;
receiving user data associated with a plurality of users associated with the real estate transaction, the plurality of users including at least a buyer and seller of real estate in the real estate transaction;
creating at least one document package corresponding to a plurality of electronic real estate transaction documents based at least in part on the real estate transaction data and user data;
determining accessibility of each of the plurality of electronic real estate transaction documents for each of the plurality of users based at least in part on the real estate transaction data and user data;
tracking modifications made to the plurality of electronic real estate transaction documents by at least one of plurality of users throughout the real estate transaction, the modifications include at least digitally signing an electronic real estate transaction document and changing real estate transaction data associated an electronic real estate transaction document;
restricting the accessibility of at least one of the plurality of electronic real estate transaction documents after the at least one of the plurality of electronic real estate transaction documents have been digitally signed; and
transmitting modified electronic real estate transaction documents to the at least one network data server for storage.

9. The method of claim 8, wherein a first electronic real estate transaction document of the plurality of electronic real estate transaction documents is divided into a plurality of sections, the accessibility of each of the sections being based at least in part on the user, one of the plurality of users being granted access to a first section of the first electronic real estate transaction document and not granted access to a second section of the first electronic real estate transaction document.

10. The method of claim 8, further comprising:
receiving the real estate transaction data from host server;
processing the plurality of electronic real estate transaction documents and the real estate transaction data;
encrypting the plurality of real estate transaction documents and the real estate transaction data;
providing encrypted data storage for storing the plurality of real estate transaction documents and the real estate transaction data;
selectively controlling the ingress and egress of the plurality of real estate transaction documents and real estate transaction data to and from host server; and
enabling at least one of the plurality of users to digital sign at least one selected electronic real estate transaction document.

11. The method of claim 8, wherein the encrypted data storage provides a secure symmetric-key encryption using 256-bit encryption keys for encrypting the real estate transaction data and the plurality of electronic real estate transaction documents.

12. The method of claim 8, wherein the at least one package is a plurality of packages, the plurality of packages including at least a contract negotiation package, a pre-approval package, appraiser package and title package; and
the method further comprising combining the plurality of packages into a closing package during closing of the real estate transaction for the buyer and seller to sign.

13. The method of claim 8, wherein the real estate transaction documents comprise a sales contract, a mortgage document and at least one real estate closing document.

14. The method of claim 8, wherein the real estate transaction includes a plurality of stages, the plurality of stages including at least an appraisal stage, inspection stage, title search stage, loan approval stage and closing stage; and
the method further comprising restricting the accessibility of at least one of the plurality of electronic real estate documents based at least in part the stage of the real estate transaction.

15. A real estate transaction system, comprising:
a host server in communication with the at least one network data server, the host server configured to:
receive real estate transaction data associated with a real estate transaction;
receive user data associated with a plurality of users associated with the real estate transaction, the plurality of users including at least a buyer and seller of real estate in the real estate transaction;
create at least one document package corresponding to a plurality of electronic real estate transaction documents based at least in part on the real estate transaction data and user data;
determine accessibility of each of the plurality of electronic real estate transaction documents for each of the plurality of users based at least in part on the real estate transaction data and user data;
track modifications made to the plurality of electronic real estate transaction documents by at least one of plurality of users throughout the real estate transaction, the modifications include at least digitally signing an electronic real estate transaction document and changing real estate transaction data associated an electronic real estate transaction document;
restrict the accessibility of at least one of the plurality of electronic real estate transaction documents after the at least one of the plurality of electronic real estate transaction documents have been digitally signed; and
transmit modified electronic real estate transaction documents to the at least one network data server for storage; and
the at least one network data server is configured to:
receive the real estate transaction data from host server;
process the plurality of electronic real estate transaction documents and the real estate transaction data;
encrypt the plurality of real estate transaction documents and the real estate transaction data;
provide encrypted data storage for storing the plurality of real estate transaction documents and the real estate transaction data;
selectively control the ingress and egress of the plurality of real estate transaction documents and real estate transaction data to and from host server; and
enable at least one of the plurality of users to digital sign at least one selected electronic real estate transaction document.

16. The system of claim 15, wherein a first electronic real estate transaction document of the plurality of electronic real estate transaction documents is divided into a plurality of sections, the accessibility of each of the sections being based at least in part on the user, one of the plurality of users being granted access to a first section of the first electronic real estate transaction document and not granted access to a second section of the first electronic real estate transaction document.

17. The system of claim 15, wherein the encrypted data storage provides a secure symmetric-key encryption using 256-bit encryption keys for encrypting the real estate transaction data and the plurality of electronic real estate transaction documents.

18. The system of claim 15, wherein the at least one package is a plurality of packages, the plurality of packages including at least a contract negotiation package, a pre-approval package, appraiser package and title package; and
the host server is further configured to combine the plurality of packages into a closing package during closing of the real estate transaction for the buyer and seller to sign.

19. The system of claim 15, wherein the real estate transaction documents comprise a sales contract, a mortgage document and at least one real estate closing document.

20. The system of claim 15, wherein the real estate transaction includes a plurality of stages, the plurality of stages including at least an appraisal stage, inspection stage, title search stage, loan approval stage and closing stage; and
the host server is further configured to restrict the accessibility of at least one of the plurality of electronic real estate documents based at least in part the stage of the real estate transaction.
